(19) United States
(12) Patent Application Publication
(10) Pub. No.: US 2016/0062725 A1
(43) Pub. Date: Mar. 3, 2016

(54) MULTISCREEN DISPLAY APPARATUS

(71) Applicant: MITSUBISHI ELECTRIC CORPORATION, Tokyo (JP)

(72) Inventors: Kensuke ODAGIRI, Tokyo (JP); Yoshinori ASAMURA, Tokyo (JP); Yasunori WADA, Tokyo (JP)

(73) Assignee: MITSUBISHI ELECTRIC CORPORATION, Tokyo (JP)

(21) Appl. No.: 14/823,130

(22) Filed: Aug. 11, 2015

(30) Foreign Application Priority Data
Aug. 26, 2014 (JP) 2014-171393
Aug. 26, 2014 (JP) 2014-171522

(51) Int. Cl. G06F 3/14; G09G 3/36; H04N 9/12

(52) U.S. Cl. CPC G06F 3/1446; H04N 9/12; G06F 3/1407; G09G 3/36; G09G 2300/026; G09G 2340/04

(57) ABSTRACT

A calculating unit of a master apparatus that comes first in a transmission sequence calculates coordinates of a plurality of video display apparatuses on a multiscreen on the basis of arrangement information and the transmission sequence. The calculating unit an identification number on the basis of an identification setting rule. A setting unit performs a processing for setting the identification number of each of the video display apparatuses with the calculated coordinates to the video display apparatus concerned.

### BACKGROUND OF THE INVENTION

1. Field of the Invention

The present invention relates to a multiscreen display apparatus that displays video on a multiscreen including a plurality of screens.

2. Description of the Background Art

One of the apparatuses that display video on large screens is a multiscreen display apparatus that displays video on a multiscreen including a plurality of screens. In the multiscreen display apparatus, a plurality of video display apparatuses operate in conjunction with one another. That is, the multiscreen display operates as one apparatus through the plurality of video display apparatuses. The multiscreen display apparatus includes the plurality of video display apparatuses arranged in matrix. The matrix has, for example, three rows and three columns. This configuration provides a large screen.

In the multiscreen display apparatus including the plurality of video display apparatuses, video on the individual screens included in the multiscreen needs to be equal in brightness and display quality. Thus, the brightness and display quality of video displayed on the screens of the individual video display apparatuses need to be adjusted for each of the video display apparatuses. To make such adjustments, identification numbers for identifying individual video display apparatuses need to be set.

Japanese Patent Application Laid-Open No. 2006-254275 (paragraphs 0020 to 0026, FIG. 4) discloses the technique (hereinafter also referred to as “related art A”) for setting identification numbers (ID numbers) to individual display apparatuses through the use of a remote controller.

In a case where video is displayed on a multiscreen as a whole, each of the screens included in the multiscreen displays an expanded view of a part of the video. In this case, the position of the screen of each video display apparatus needs to be identified in the multiscreen.

Japanese Patent No. 5193563 (paragraphs 0069 to 0074, FIG. 7) discloses the technique (hereinafter referred to as “related art B”) for detecting the position of each of a plurality of display apparatuses daisy-chain connected through, for example, dedicated serial cables. In particular, according to the related art B, an imaging apparatus captures the images displayed on individual display apparatuses. Then, the position of the individual display apparatus is detected on the basis of the captured images.

### SUMMARY OF THE INVENTION

Unfortunately, the related arts A and B cause the following problems. In particular, the related art A, with which the identification numbers (ID numbers) being the identification information are set to individual display apparatuses (video display apparatuses) included in the multi-display, requires the setting of identification numbers for the individual video display apparatuses each serving as a display apparatus through the use of, for example, a remote controller. Thus, it takes a lot of time to set the identification numbers.

The related art B enables the quick setting of identification numbers through the use of the detected position of each of the display apparatuses (video display apparatuses), thereby resolving the problem arising from the related art A.

The related art B additionally requires an imaging apparatus for detecting the position of each of the display apparatuses (video display apparatuses). Thus, the configuration employing the related art B is complex and is thus costly.

The present invention has an object to provide a multiscreen display apparatus capable of setting identification numbers to video display apparatuses through a simple configuration.

A multiscreen display apparatus according to one aspect of the present invention includes a plurality of video display apparatuses arranged in matrix and daisy-chain connected through a communication cable such that screens of the plurality of video display apparatuses form a multiscreen having a rectangular shape. For the plurality of video display apparatuses, a transmission sequence in which information is transmitted between the plurality of video display apparatuses through the daisy chain connection is defined. A reference video display apparatus that comes first in the transmission sequence from among the plurality of video display apparatuses includes a calculating unit that calculates coordinates of the plurality of video display apparatuses on the multiscreen on the basis of the transmission sequence and arrangement information for specifying an arrangement configuration of the plurality of video display apparatuses. The calculating unit calculates an identification number for identifying each of the plurality of video display apparatuses on the basis of a predetermined rule for setting the identification number to each of the plurality of video display apparatuses. The reference video display apparatus includes a setting unit that performs a processing for setting the identification number of each of the plurality of video display apparatuses with the calculated coordinates to the video display apparatus concerned.

According to the present invention, the calculating unit of the reference video display apparatus that comes first in the transmission sequence calculates the coordinates of the plurality of video display apparatuses on the multiscreen on the basis of the arrangement information and the transmission sequence described above. The calculating unit calculates the identification number on the basis of the predetermined rule for setting the identification number to each of the plurality of video display apparatuses. The setting unit performs the processing for setting the identification number of each of the plurality of video display apparatuses with the calculated coordinates to the video display apparatus concerned.

For example, this eliminates the need for the conventional imaging apparatus and the like for calculating the coordinates of the individual video display apparatus. Thus, the coordinates of the individual video display apparatus can be calculated through the simple configuration. As described above, the setting unit performs the processing for setting the identification number to each of the video display apparatuses with the calculated coordinates to the video display apparatus concerned. Thus, the identification numbers can be set to the individual video display apparatuses through the simple configuration.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a configuration of a multiscreen display apparatus according to a first preferred embodiment of the present invention;

FIG. 2 is a front view of the multiscreen display apparatus according to the first preferred embodiment of the present invention;

FIG. 3 is a diagram illustrating an example of the configuration of a multiscreen according to the first preferred embodiment of the present invention;

FIG. 4 is a block diagram illustrating a configuration of a video display apparatus according to the first preferred embodiment of the present invention;

FIG. 5 is a diagram describing a configuration for displaying video on the multiscreen;

FIG. 6 is a flowchart of an identification information setting correspondence processing BX;

FIG. 7 is a diagram describing the position of a master apparatus;

FIG. 8 is a diagram describing a cable connection configuration depending on the position of the master apparatus;

FIG. 9 is a diagram illustrating another example of the connection configuration of the individual video display apparatuses included in the multiscreen display apparatus;

FIG. 10 is a diagram describing an identification setting rule for setting identification numbers i;

FIG. 11 is a flowchart of an identification information setting correspondence processing BM;

FIG. 12 is a flowchart of a coordinate calculation processing;

FIG. 13 is a diagram describing the definition of directions depending on the position of the master apparatus;

FIG. 14 is a flowchart of an identification information calculation processing BM;

FIG. 15 is a flowchart of an identification information setting correspondence processing BS;

FIG. 16 is a diagram illustrating an example of the identification numbers i and coordinates P set to the individual video display apparatuses;

FIG. 17 is a flowchart of an identification information setting correspondence processing NX;

FIG. 18 is a diagram describing an identification setting rule for setting identification addresses;

FIG. 19 is a flowchart of an identification information setting correspondence processing NM;

FIG. 20 is a flowchart of an identification information calculation processing NM;

FIG. 21 a flowchart of an identification information setting correspondence processing NS;

FIG. 22 is a diagram illustrating an example of identification addresses and the coordinates P set to the individual video display apparatuses; and

FIG. 23 is a configuration diagram of hardware of the video display apparatus.

### DESCRIPTION OF THE PREFERRED EMBODIMENTS

With reference to the drawings, the following describes preferred embodiments of the present invention. In the descriptions below, the same reference signs indicate the same constituent components, which holds true for the names and functions thereof. Therefore, detailed descriptions thereof may be omitted.

### First Preferred Embodiment

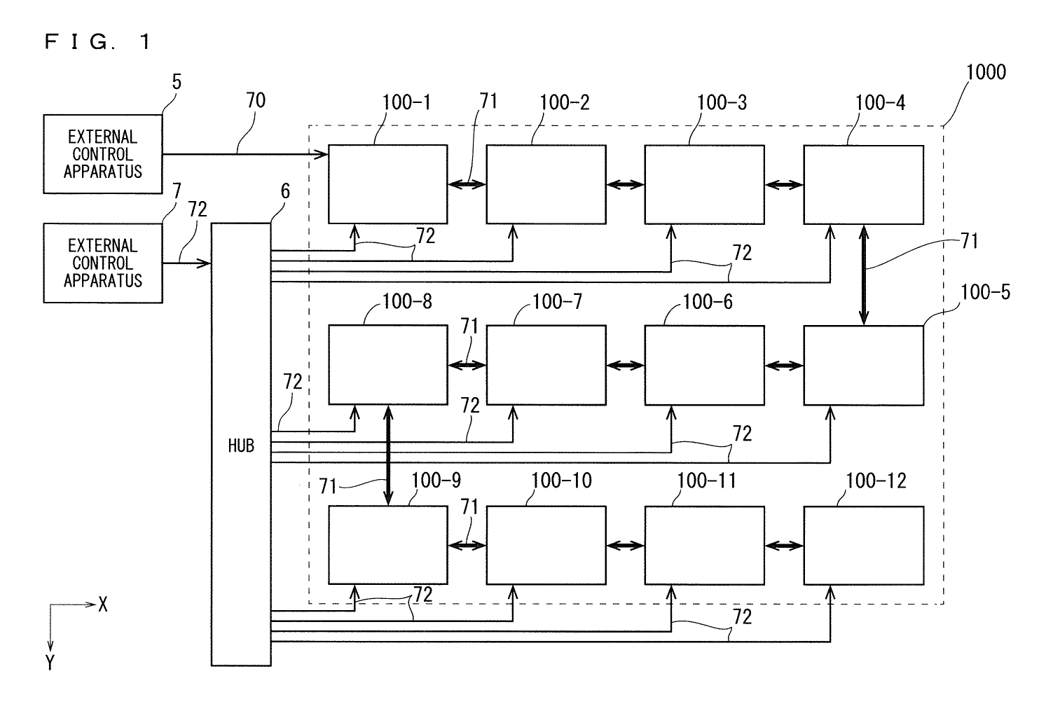

FIG. 1 is a diagram illustrating a configuration of a multiscreen display apparatus 1000 according to the first preferred embodiment of the present invention. With reference to FIG. 1, the X direction and the Y direction are orthogonal to each other. The X direction and the Y direction indicated in the subsequent drawings are also orthogonal to each other. The direction including the X direction and the direction (−X direction) opposite to the X direction is hereinafter also referred to as “X axis direction.” The direction including the Y direction and the direction (−Y direction) opposite to the Y direction is hereinafter also referred to as “Y axis direction.” The plane surface including the X axis direction and the Y axis direction is hereinafter also referred to as “X-Y plane.”

FIG. 1 also shows external control apparatuses 5 and 7 as well as a hub 6 that are not included in the multiscreen display apparatus 1000. The external control apparatuses 5 and 7 are, for example, personal computers (PCs). The external control apparatus 5, which will be described later in detail, controls the multiscreen display apparatus 1000. After the setting of identification addresses which will be described later, the external control apparatus 7 controls the multiscreen display apparatus 1000 through a network. The network is, for example, a local area network (LAN). The external control apparatuses 5 and 7 each include an interface (hereinafter also referred to as “operation interface”) operated by an operator. The operation interface is, for example, a keyboard. The external control apparatus 5 is not limited to the PC and may be, for example, a remote controller.

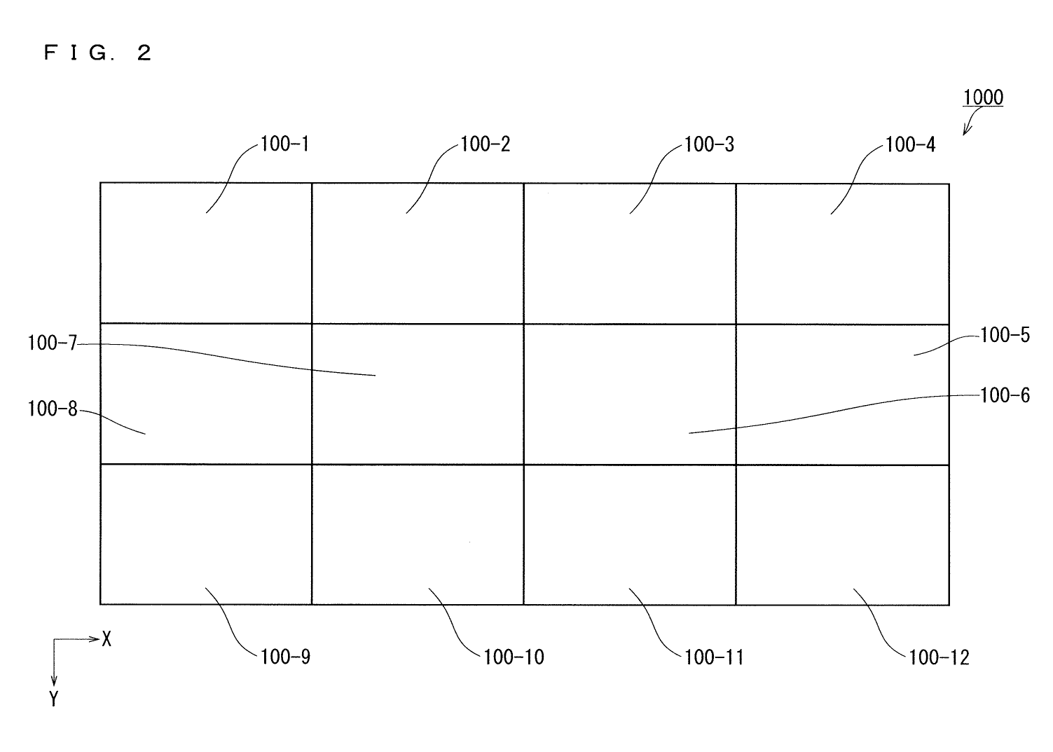

FIG. 2 is a front view of the multiscreen display apparatus 1000 according to the first preferred embodiment of the present invention. As shown in FIGS. 1 and 2, the multiscreen display apparatus 1000 includes video display apparatuses 100-1, 100-2, 100-3, 100-4, 100-5, 100-6, 100-7, 100-8, 100-9, 100-10, 100-11, and 100-12.

The video display apparatuses 100-1, 100-2, 100-3, 100-4, 100-5, 100-6, 100-7, 100-8, 100-9, 100-10, 100-11, and 100-12, which will be described later in detail, each have the same configuration. Each of the video display apparatuses 100-1, 100-2, 100-3, 100-4, 100-5, 100-6, 100-7, 100-8, 100-9, 100-10, 100-11, and 100-12 is hereinafter also referred to as “video display apparatus 100.”

The multiscreen display apparatus 1000 includes twelve video display apparatuses 100. The number of video display apparatuses 100 included in the multiscreen display apparatus 1000 is not limited and may be any value from two to eleven, thirteen, or more.

In the multiscreen display apparatus 1000, the plurality of video display apparatuses 100 operate in conjunction with one another, thereby functioning as one display or a plurality of displays. The multiscreen display apparatus 1000 includes twelve video display apparatuses 100 arranged in, for example, a matrix with three rows and four columns as shown in FIG. 2. The plurality of video display apparatuses 100 included in the multiscreen display apparatus 1000 are daisy-chain connected through a communication cable 71.

The sequence in which information (data) is transmitted between the plurality of video display apparatuses 100 that are daisy-chain connected is hereinafter also referred to as “transmission sequence.” That is, for the plurality of video display apparatuses 100 included in the multiscreen display apparatus 1000, the sequence (transmission sequence) in which information (data) is transmitted between the plurality of video display apparatuses 100 through the daisy chain connection is defined.

The communication according to the transmission sequence described above is hereinafter also referred to as “daisy chain communication.” In the daisy chain communication, information (data) is transmitted according to the transmission sequence between the plurality of video display apparatuses 100 that are daisy-chain connected. For example, in the daisy chain communication, information (data) is transmitted in the stated order of the video display apparatuses 100-1, 100-2, 100-3, 100-4, 100-5, 100-6, 100-7, 100-8, 100-9, 100-10, 100-11, and 100-12. The communication cable 71 is the cable dedicated to the daisy chain communication.

The communication channel formed by the plurality of video display apparatuses 100 daisy-chain connected through the communication cable 71 is hereinafter also referred to as “communication channel SK.” The communication channel SK is the communication channel that follows the daisy chain connection. The communication performed through the communication channel SK is hereinafter also referred to as “communication SK.”

The communication SK includes upstream communication and the daisy chain communication. The upstream communication is the communication that follows the sequence opposite to the transmission sequence described above. In the upstream communication, the individual video display apparatuses 100 transmit information (data) to the external control apparatus 5. In the upstream communication, the video display apparatus 100-3, for example, sends information (data) to the external control apparatus 5 through a control cable 70 described below and/or the communication channel SK.

In particular, the twelve video display apparatuses 100 are daisy-chain connected such that information (data) is transmitted in the stated order of the video display apparatuses 100-1, 100-2, 100-3, 100-4, 100-5, 100-6, 100-7, 100-8, 100-9, 100-10, 100-11, and 100-12. That is, in the daisy chain communication, information (data) is transmitted according to the transmission sequence between the plurality of video display apparatuses 100 included in the multiscreen display apparatus 1000.

The number indicating the transmission sequence is hereinafter referred to as “sequence number n (n is a natural number)” or “sequence number.” The sequence number n is the order in which data is transmitted between the plurality of video display apparatuses 100 included in the multiscreen display apparatuses 1000. The sequence number n stands at 1, 2, 3, 4, 5, 6, 7, 8, 9, 10, 11, and 12 for the video display apparatuses 100-1, 100-2, 100-3, 100-4, 100-5, 100-6, 100-7, 100-8, 100-9, 100-10, 100-11, and 100-12, respectively.

The video display apparatus 100 having the sequence number set thereto that is greater by 1 than the sequence number of another video display apparatus 100 is hereinafter also referred to as “subsequent adjacent video display apparatus 100.” The video display apparatus 100 having the sequence number set thereto that is smaller by 1 than the sequence number of another video display apparatus 100 is hereinafter also referred to as “previous adjacent video display apparatus 100.”

The video display apparatus 100 having the greatest sequence number among the plurality of video display apparatuses 100 included in the multiscreen display apparatus 1000 is hereinafter also referred to as “terminal video display apparatus.” The terminal video display apparatus is, for example, the video display apparatus 100-12. The video display apparatuses 100 other than the terminal video display apparatus among the plurality of video display apparatuses 100 included in the multiscreen display apparatus 1000 is hereinafter also referred to as “non-terminal video display apparatus.”

The external control apparatus 7 is connected to each of the video display apparatuses 100 included in the multiscreen display apparatus 1000 through a network cable 72 via the hub 6. For example, as shown in FIG. 1, the external control apparatus 7 is networked with each of the video display apparatuses 100-1, 100-2, 100-3, 100-4, 100-5, 100-6, 100-7, 100-8, 100-9, 100-10, 100-11, and 100-12 through the network cable 7 via the hub 6.

Thus, the communication channel supported by the network cable 72 and the hub 6 forms a network (hereinafter also referred to as “network NW”). The network NW is, for example, a LAN. The hub 6 is the switching hub that relays data in the communication supported by the network.

The communication channel forming the network NW is hereinafter also referred to as “communication channel NK.” The plurality of video display apparatuses 100 included in the multiscreen display apparatus 1000 are connected to the outside (the external control apparatus 7) so as to form the network NW using the communication channel NK separate from the communication channel SK following the daisy chain connection.

The communication supported by the communication channel NK is hereinafter also referred to as “network communication.” In the network communication, the external control apparatus 7, for example, communicates with each of the video display apparatuses 100 through the network cable 72 and the hub 6.

The video display apparatus 100 is a liquid crystal display (LCD). The video display apparatus 100 is not limited to the LCD and may be a rear-projection display apparatus. The rear-projection display apparatus provides displaying by projecting video on the screen from the back surface of the screen. The individual video display apparatuses 100 included in the multiscreen display apparatus 1000 display video on the basis of the video signals input from the outside.

The video display apparatuses 100 each have a rectangular parallelepiped shape. As shown in FIG. 2, the individual video display apparatuses 100 are arranged in matrix in the X-Y plane. The individual video display apparatuses 100 do not necessarily have the rectangular parallelepiped shape and may have another shape that allows the individual video display apparatuses 100 to be arranged in matrix.

The video display apparatuses 100-1, 100-2, 100-3, 100-4, 100-5, 100-6, 100-7, 100-8, 100-9, 100-10, 100-11, and 100-12 include screens 10-1, 10-2, 10-3, 10-4, 10-5, 10-6, 10-7, 10-8, 10-9, 10-10, 10-11, and 10-12, respectively.

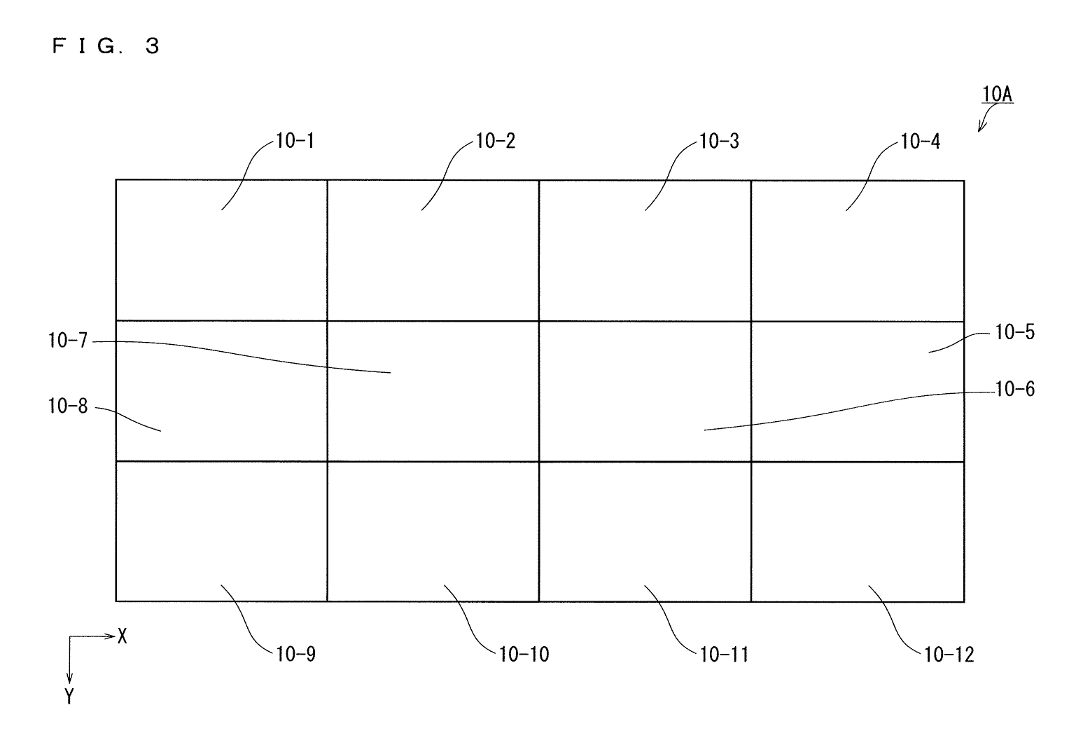

The multiscreen display apparatus 1000 includes a multiscreen 10A shown in FIG. 3. The multiscreen 10A is parallel with the X-Y plane. As shown in FIG. 3, the multiscreen 10A is a screen including the screens 10-1, 10-2, 10-3, 10-4, 10-5, 10-6, 10-7, 10-8, 10-9, 10-10, 10-11, and 10-12 that are arranged in matrix. The multiscreen 10A has a rectangular shape.

Each of the screens 10-1, 10-2, 10-3, 10-4, 10-5, 10-6, 10-7, 10-8, 10-9, 10-10, 10-11, and 10-12 is hereinafter also referred to as “screen 10.” The multiscreen 10A includes the plurality of screens 10 of the plurality of video display apparatuses 100 arranged in matrix. The screen 10 is the screen for displaying video. The screen 10 is, for example, a sheet of glass or a screen. The number of the screens 10 included in the multiscreen 10A is not limited and may be any value from two to eleven, thirteen, or more.

The screen 10 of the individual video display apparatus 100 is, for example, disposed on the entire front surface of the video display apparatus 100. Thus, the multiscreen 10A in FIG. 3 has the same shape as the X-Y plane of the multiscreen display apparatus 1000 in FIG. 2.

The multiscreen display apparatus 1000 includes the plurality of video display apparatuses 100 arranged in matrix such that the screens 10 of the plurality of video display apparatuses 100 form the multiscreen 10A having a rectangular shape. The individual video display apparatuses 100 display video on the screens 10, whereby the multiscreen display apparatus 1000 displays video on the multiscreen 10A.

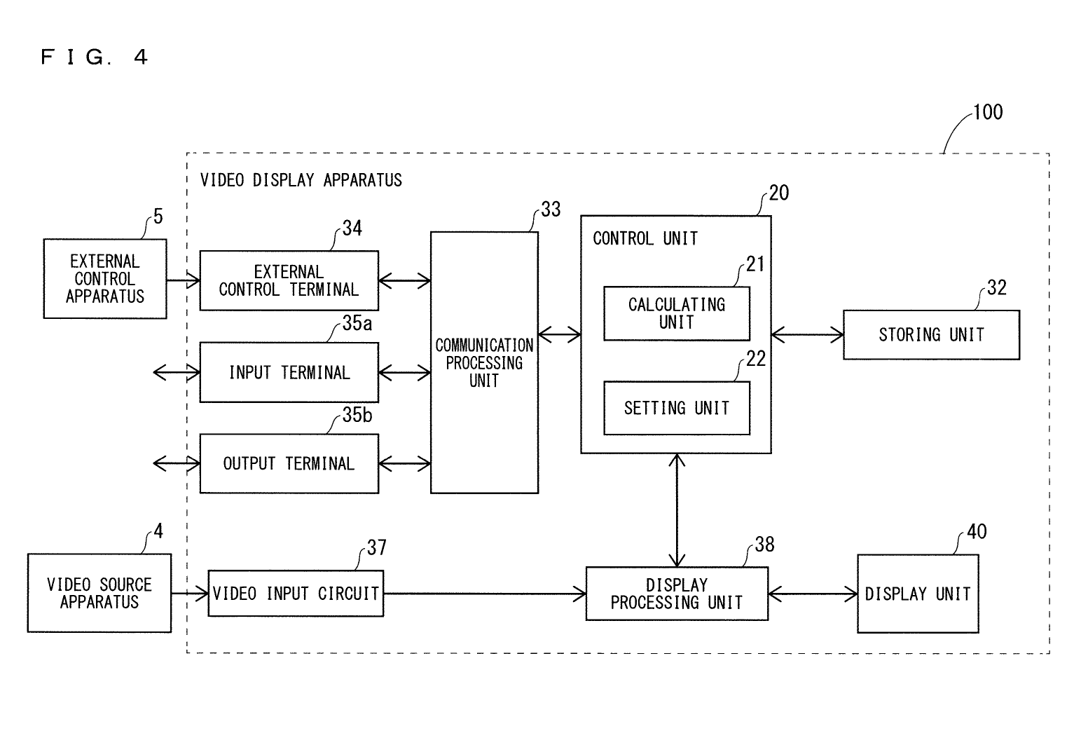

The following describes the configuration of the video display apparatuses 100. FIG. 4 is a block diagram illustrating the configuration of the video display apparatus 100 according to the first preferred embodiment of the present invention. FIG. 4 also shows a video source apparatus 4 and the external control apparatus 5 that are not included in the video display apparatus 100.

The video display apparatus 100 includes a control unit 20, a storing unit 32, an external control terminal 34, an input terminal 35a, an output terminal 35b, a communication processing unit 33, a video input circuit 37, a display processing unit 38, and a display unit 40.

The control unit 20 controls each unit (such as the communication processing unit 33 and the display processing unit 38) of the video display apparatus 100. The control unit 20 is, for example, a central processing unit (CPU). The control unit 20 includes a calculating unit 21 and a setting unit 22. The calculating unit 21, which will be described later in detail, performs various kinds of computation. The setting unit 22, which will be described later in detail, sets various kinds of information.

The entirety or a part of the calculating unit 21 and the setting unit 22 included in the control unit 20 may be configured with the hardware such as a large scale integration (LSI). The entirety or a part of the calculating unit 21 and the setting unit 22 may be a program module executed by a processor such as a CPU.

The input terminal 35a is an input terminal for receiving data (information) in the daisy chain communication described above. The output terminal 35b is a terminal for sending data (information) in the daisy chain communication. Each of the input terminal 35a and the output terminal 35b is, in some cases, used to receive and send data (information) for communication other than the daisy chain communication.

As described above, the plurality of video display apparatuses 100 included in the multiscreen display apparatus 1000 are daisy-chain connected through the communication cable 71. In particular, the output terminal 35b of the video display apparatus 100 having the sequence number n is connected to the input terminal 35a of the video display apparatus 100 having the sequence number (n+1) through the communication cable 71.

As an example, the output terminal 35b of the video display apparatus 100-1 is connected to the input terminal 35a of the video display apparatus 100-2 through the communication cable 71. As another example, the output terminal 35b of the video display apparatus 100-2 is connected to the input terminal 35a of the video display apparatus 100-3 through the communication cable 71.

The video display apparatus 100 that comes first in the transmission sequence from among the plurality of the video display apparatuses 100 included in the multiscreen display apparatus 1000 is hereinafter also referred to as “reference video display apparatus” or “master apparatus.” The video display apparatus 100-1 is the reference video display apparatus (master apparatus).

The video display apparatuses 100 other than the master apparatus among the plurality of video display apparatuses 100 included in the multiscreen display apparatus 1000 are hereinafter also referred to as “slave apparatuses.” For example, the video display apparatuses 100-2, 100-3, 100-4, 100-5, 100-6, 100-7, 100-8, 100-9, 100-10, 100-11, and 100-12 shown in FIG. 1 are slave apparatuses. That is, the multiscreen display apparatus 1000 includes one master apparatus and at least one slave apparatus.

The external control terminal 34 of the master apparatus includes a terminal (hereinafter also referred to as “control communication terminal”) used in the communication with the external control apparatus 5. The control communication terminal (the external control terminal 34) of the master apparatus is connected to the external control apparatus 5 through the control cable 70. Thus, the master apparatus is connected to the external control apparatus 5 through the control cable 70.

The external control terminals 34 of the individual video display apparatuses 100 include terminals (hereinafter also referred to as “network terminals”) used in the network communication with the external control apparatus 7. The network terminals (the external control terminals 34) are connected to the external control apparatus 7 (not shown) through the network cable 72 via the hub 6.

The video display apparatuses 100 have, as the operation modes for communication, the normal mode and the identification setting mode. The normal mode is the mode in which the video display apparatuses 100 send data (information) according to the transmission sequence described above. The identification setting mode, which will be described later in detail, is the mode for setting the identification number described below and/or the identification address described below being the identification information.

The video display apparatuses 100 have the information input mode for inputting information. The information input mode is enabled or disabled by the video display apparatuses 100. The video display apparatuses 100 with the information input mode in the enable state are capable of receiving an input of information from the outside.

The communication processing unit 33 controls various kinds of communication. The communication processing unit 33 has the normal state and the upstream transfer suspension state as the state for controlling communication.

For the network communication described above, the communication processing unit 33 is continually set in the normal state. In the network communication, the communication processing unit 33 sends data received by the external control terminal 34 to the control unit 20.

For the communication SK described above, the communication processing unit 33 performs the following processing. In particular, the communication processing unit 33, being in the normal state, of the master apparatus sends (transfers) the data (signal) received by the external control terminal 34 to the output terminal 35b. The data (signal) sent from the output terminal 35b of the master apparatus is sent to the video display 100 (slave apparatus) coming second in the transmission sequence.

The communication processing unit 33, being in the normal state, of the individual slave apparatus sends (transfers) the data (signal) received by the input terminal 35a to the output terminal 35b. The data sent to the output terminal 35a is sent to the subsequent video display apparatus 100 (slave apparatus) adjacent to the relevant slave apparatus.

The communication processing unit 33, being in the normal state, of the individual slave apparatus sends (transfers) the data received by the output terminal 35b to the input terminal 35a. The data sent to the input terminal 35a is sent to the previous video display apparatus 100 (the master slave apparatus or the slave apparatus) adjacent to the relevant slave apparatus.

The communication processing unit 33, being in the normal state, of the master apparatus sends, to the control unit 20, the data received by the external control terminal 34, the input terminal 35a, or the output terminal 35b. The communication processing unit 33 in the normal state sends the data (signal) received from the control unit 20 to the external control terminal 34, the input terminal 35a, or the output terminal 35b in accordance with the destination (delivery target) of the data. The destination of the data is, for example, the external control apparatus 5, the external control apparatus 7, or another video display apparatus 100. The communication processing unit 33 functions as the communication switching unit that changes the communication partner depending on circumstances.

The communication processing unit 33, being in the normal state, of the individual slave apparatus sends, to the control unit 20, the data received by the input terminal 35a or the output terminal 35b. The communication processing unit 33 in the normal state sends the data (signal) received from the control unit 20 to the input terminal 35a or the output terminal 35b in accordance with the destination of the relevant data.

The communication processing unit 33 in the upstream transfer suspension state sends the data received by the output terminal 35b only to the control unit 20 and does not send the data to the input terminal 35a. The communication processing unit 33 in the upstream transfer suspension state sends (transfers) the data (signal) received by the input terminal 35a to the output terminal 35b.

The video input circuit 37 receives a video signal output by the video source apparatus 4 located outside the multiscreen display apparatus 1000. Then, the video input circuit 37 outputs the video signal converted into a digital signal to the display processing unit 38.

The display processing unit 38 controls the display unit 40. In particular, the display processing unit 38 is the image processing circuit that subjects the image indicated by the received video signal to the image processing including the adjustment of image quality. The display processing unit 38 also has the function of image processing including the on-screen display (OSD). The display processing unit 38 converts the video signal having undergone the image processing into a video signal in the format that can be processed by the display unit 40.

The display processing unit 38 sends, as required, a video signal indicating an image including information such as a menu superimposed on an image indicated by a video signal to the display unit 40 in accordance with the instructions from the control unit 20.

The display unit 40 is the device for displaying video on the screen 10 (not shown). The display unit 40 displays the image indicated by the video signal received from the display processing unit 38 on the screen 10. The display unit 40 is a LCD panel. The display unit 40 is not limited to the LCD panel and may be an apparatus employing another system for displaying an image. The display unit 40, which could be a rear-projection display apparatus, may be, for example, a display device for projecting video onto the screen 10.

As described above, the external control apparatus 7 is connected to each of the video display apparatuses 100 included in the multiscreen display apparatus 1000 through the network cable 72 via the hub 6. That is, the external control apparatus 7 and the individual video display apparatuses 100 are connected so as to form the network NW described above.

The individual video display apparatuses 100 need to have the distinctive identification numbers set thereto in order to allow the external control apparatus 5 to individually control a given one of the video display apparatuses 100 included in the multiscreen display apparatus 1000. The identification numbers are the identification numbers (IDs) for identifying the individual video display apparatuses 100. The identification number is hereinafter also referred to as “identification number i.”

The individual video display apparatuses 100 need to have the distinctive identification information set thereto in order to allow the external control apparatus 7 to individually control a given one of the video display apparatuses 100 included in the multiscreen display apparatus 1000. The identification information is the identification address for identifying the individual video display apparatuses 100 in the network NW. The identification address will be described later in detail.

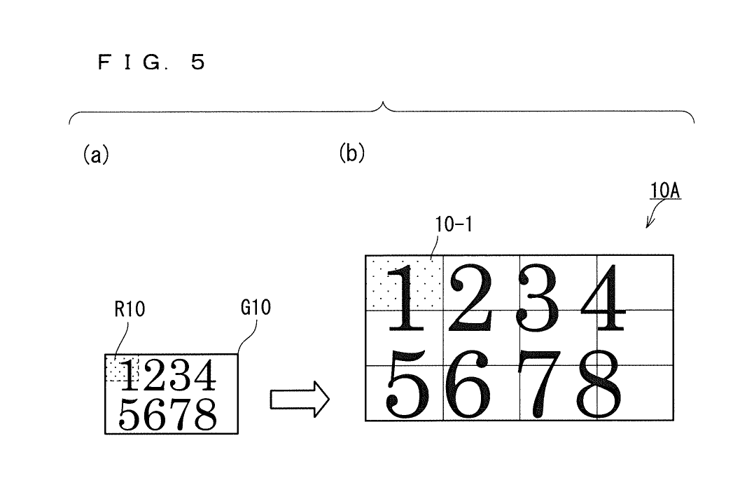

Assume that the multiscreen display apparatus 1000 performs the display enlargement processing. For example, assume that the display enlargement processing involves the processing of displaying an image G10 shown in part (a) in FIG. 5 on the entirety of the multiscreen 10A. In other words, assume that the multiscreen display apparatus 1000 performs the processing of providing enlarged displaying of the image G10. In this case, the same image G10 is sent to the individual video display apparatuses 100. Each of the video display apparatuses 100 provides enlarged displaying of the respective target region of the image G10. For example, the video display apparatus 100-1 enlarges the image in a region R10 out of the image G10 and displays it on the screen 10-1 (see part (b) in FIG. 5).

For the display enlargement processing, matrix information MJ (arrangement information KJ described below), the sequence number described above, coordinates P, and the like are set in advance to the individual video display apparatuses 100 included in the multiscreen display apparatus 1000. The matrix information MJ is the information on the matrix for specifying the positions of the individual video display apparatuses 100 on the multiscreen 10A.

The matrix for specifying the positions of the individual video display apparatuses 100 on the multiscreen 10A is hereinafter also referred to as “matrix MX.” That is, the matrix MX is the matrix corresponding to the plurality of video display apparatuses 100 arranged in matrix so as to form the multiscreen display apparatus 1000. For example, with reference to FIG. 2, the multiscreen display apparatus 1000 includes twelve video display apparatuses 100 arranged in a matrix, being the matrix MX, with three rows and four columns. The matrix information MJ includes the number of rows rw (rw is a natural number) and the number of columns (cl is a natural number) of the matrix MX.

The number of the video display apparatuses 100 in the horizontal direction (the X axis direction) in the multiscreen display apparatus 1000 including the plurality of video display apparatuses 100 arranged in matrix is hereinafter also referred to as “horizontal number Hm.” Hm is a natural number. The horizontal number Hm is equal to the number of columns cl.

The number of the video display apparatuses 100 in the vertical direction (the Y axis direction) in the multiscreen display apparatus 1000 including the plurality of video display apparatuses 100 arranged in matrix is hereinafter also referred to as “vertical number Vm.” Vm is a natural number. The vertical number Vm is equal to the number of rows rw. For example, in the configuration shown in FIG. 2, the horizontal number Hm stands at 4 and the vertical number Vm stands at 3. The arrangement information KJ is composed of the horizontal number Hm and the vertical number Vm.

The arrangement information KJ is the information for indicating the arrangement configuration of the video display apparatuses 100. In particular, the arrangement information KJ is the information for specifying the arrangement configuration of the plurality of video display apparatuses 100 included in the multiscreen display apparatus 1000. As described above, the horizontal number Hm is equal to the number of columns cl and the vertical number Vm is equal to the number of rows rw. That is, the arrangement information KJ is composed of the number of rows rw and the number of columns cl of the matrix MX.

The coordinates P are the coordinates of the individual video display apparatus 100 on the multiscreen 10A. The coordinates P are expressed as (HL (natural number), VL (natural number)). With respect to the coordinates P, “HL” indicates the coordinate (position) of the individual video display apparatus 100 in the horizontal direction (the X axis direction) on the multiscreen 10A. “VL” indicates the coordinate (position) of the video display apparatus 100 in the vertical direction (the Y axis direction) on the multiscreen 10A. For example, with reference to FIG. 3, the video display apparatus 100-3 has the coordinates P (3, 1).

The individual video display apparatus 100 provides, on the entirety of the screen 10, enlarged displaying of the respective target region of the image G10 in accordance with, for example, the arrangement information KJ (the matrix information MJ), the sequence number, and the coordinates P described above. As an example, assume that the horizontal number Hm=4, the vertical number Vm=3, and the coordinates P (1, 1) are set to the video display apparatus 100-1. In this case, as shown in part (b) in FIG. 5, the video display apparatus 100-1 provides, on the screen 10-1, enlarged displaying of the image in the region R10 shown in part (a) in FIG. 5.

In this preferred embodiment, the individual video display apparatuses 100 included in the multiscreen display apparatus 1000 undergo the processing (hereinafter also referred to as “identification information setting correspondence processing”) for setting an identification number i, being the identification information, and the coordinates P. The processing performed by the external control apparatus 5 in the identification information setting correspondence processing is hereinafter also referred to as “identification information setting correspondence processing BX.” As described above, the external control apparatus 5 is connected to the external control terminal 34 of the video display apparatus 100-1 including the screen 10-1 in FIG. 3 through the control cable 70.

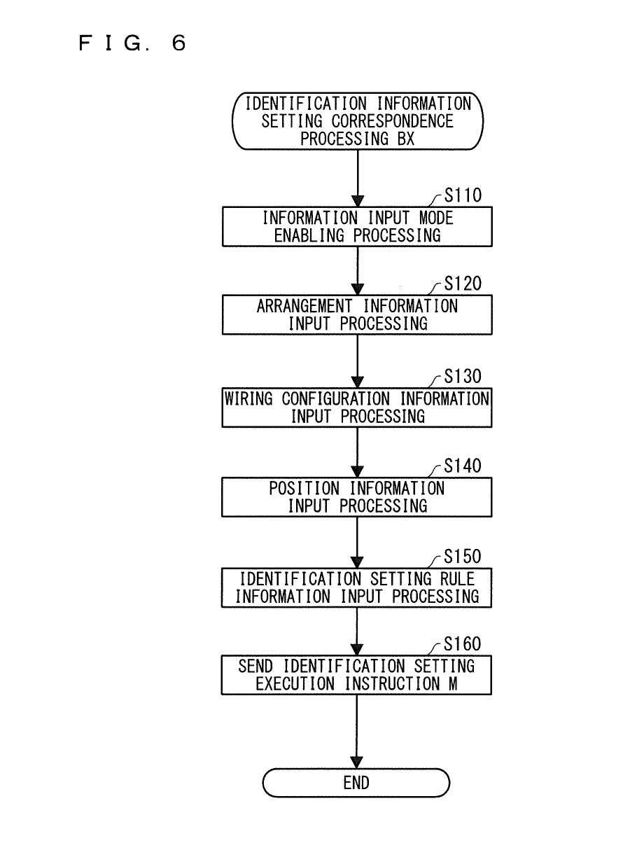

FIG. 6 is a flowchart of the identification information setting correspondence processing BX. Firstly, the processing in Step S110 is performed in the identification information setting correspondence processing BX.

In Step S110, an information input mode enabling processing is performed. In the information input mode enabling processing, the external control apparatus 5 sends an input mode enabling instruction to the master apparatus. The input mode enabling instruction is the instruction for enabling the information input mode. The master apparatus that has received the input mode enabling instruction enables the information input mode. Thus, the master apparatus can receive an input of information from the outside.

In Step S120, an arrangement information input processing for inputting the arrangement information KJ described above is performed. In the arrangement information input processing, the operator inputs, as the arrangement information KJ, the horizontal number Hm and the vertical number Vm to the external control apparatus 5, using the operation interface.

Then, the external control apparatus 5 sends, to the master apparatus, the arrangement information KJ indicating the horizontal number Hm and the vertical number Vm that have been input. Only the master apparatus is set as the delivery target of the arrangement information KJ. Thus, the communication processing unit 33 of the master apparatus receives the arrangement information KJ from the external control terminal 34. Then, the communication processing unit 33 sends the arrangement information KJ only to the control unit 20. The control unit 20 causes the storing unit 32 to store the arrangement information KJ (the horizontal number Hm and the vertical number Vm).

The communication cable 71 that connects any two of the video display apparatuses 100 adjacent to each other in the horizontal direction (the X axis direction) is hereinafter also referred to as “horizontal connection cable.” With reference to FIG. 1, the horizontal connection cable is, for example, the communication cable 71 that connects the video display apparatus 100-1 to the video display apparatus 100-2. The communication cable 71 that connects any two of the video display apparatuses 100 adjacent to each other in the vertical direction (the Y axis direction) is hereinafter also referred to as “vertical connection cable.” With reference to FIG. 1, the vertical connection cable is, for example, the communication cable 71 that connects the video display apparatus 100-4 to the video display apparatus 100-5.

In Step S130, a wiring configuration information input processing for inputting wiring configuration information W is performed. The wiring configuration information W is the information specifying the configuration of the individual communication cables 71 that connect the individual video display apparatuses 100. The configuration of the individual communication cables 71 that connect the individual video display apparatuses 100 is hereinafter also referred to as “cable connection configuration.”

The configuration in which the individual video display apparatuses 100 corresponding to each row of the matrix MX corresponding to the plurality of video display apparatuses 100 arranged in matrix are connected to each other through the horizontal connection cables is hereinafter also referred to as “horizontal connection configuration.” The horizontal connection configuration is, for example, the cable connection configuration shown in FIG. 1. In the horizontal connection configuration, the individual communication cables 71 connect the individual video display apparatuses 100 corresponding to each row of the matrix MX in the horizontal direction (the X axis direction).

In the horizontal connection configuration, the video display apparatus 100 having the greatest sequence number among the video display apparatuses 100 corresponding to each row of the matrix MX is connected to another video display apparatus 100 adjacently located in the Y direction through the communication cable 71 being the vertical connection cable. For example, with reference to FIG. 1, the video display apparatus 100-4 having the sequence number 4 among the video display apparatuses 100 corresponding to the first row of the matrix MX is connected to the video display apparatus 100-5 adjacent to the video display apparatus 100-4 in the Y direction through the communication cable 71 being the vertical connection cable.

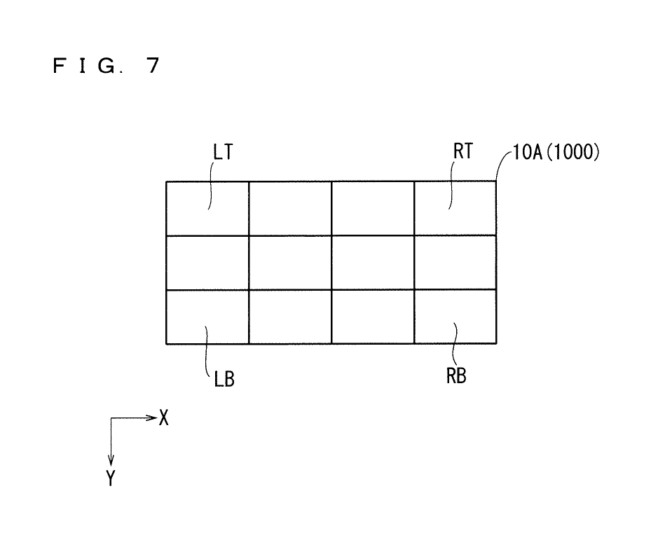

In this preferred embodiment, the reference video display apparatus (the master apparatus) is located in any one of four corners of the multiscreen 10A. The four corners include an upper-left end LT, an upper-right end RT, a lower-left end LB, and a lower-right end RB in FIG. 7. For example, the reference video display apparatus (the video display apparatus 100-1) in FIG. 2 is located in the upper-left end LT.

In the horizontal connection configuration, the vertical connection cables are located in different positions depending on the position of the reference video display apparatus (the master apparatus). In particular, in the horizontal connection configuration, the vertical connection cables are located in different positions depending on the position of the reference video display apparatus (the master apparatus), which is located in the upper-left end LT, the upper-right end RT, the lower-left end LB, or the lower-right end RB.

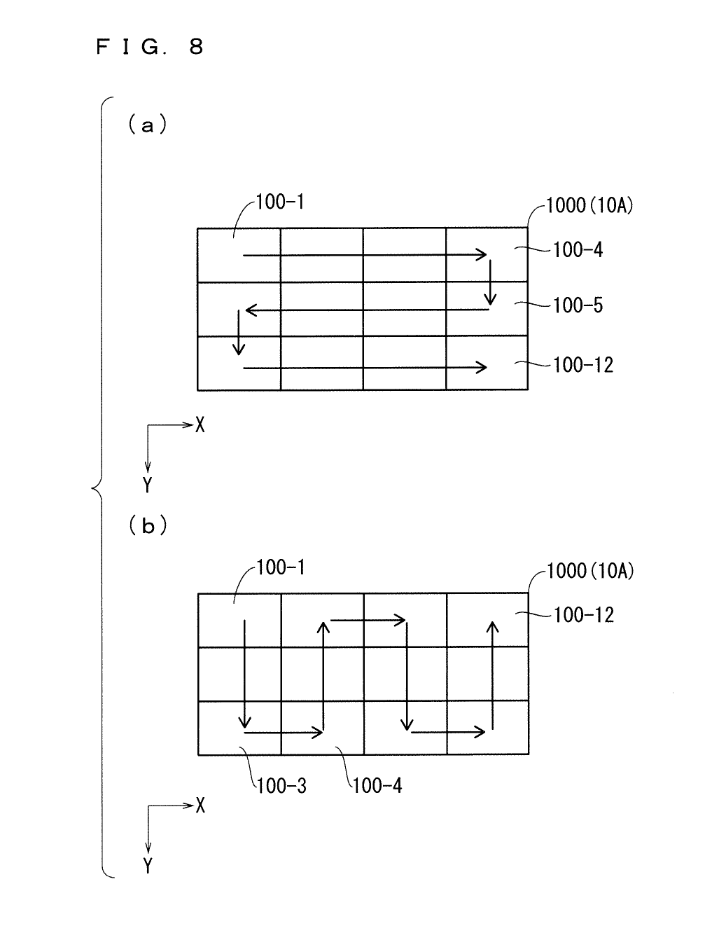

As an example, assume that the reference video display apparatus (the master apparatus) among the video display apparatuses 100 in the cable connection configuration in FIG. 1 is located in the upper-left end LT. In this case, for example, the vertical connection cable is positioned so as to connect the video display apparatus 100-4 in the upper-right end RT to the video display apparatus 100-5 adjacent to the video display apparatus 100-4 in the Y direction. In the horizontal connection configuration of the above case, the individual video display apparatuses 100 are connected to each other through the communication cable 71 such that data is transmitted in the transmission sequence indicated by the arrows in part (a) in FIG. 8.

As an example, assume that the reference video display apparatus (the master apparatus) is located in the upper-right end RT in the horizontal connection configuration. In this case, for example, the vertical connection cable is positioned so as to connect the video display apparatus 100 in the upper-left end LT to another video display apparatus 100 adjacently located in the Y direction.

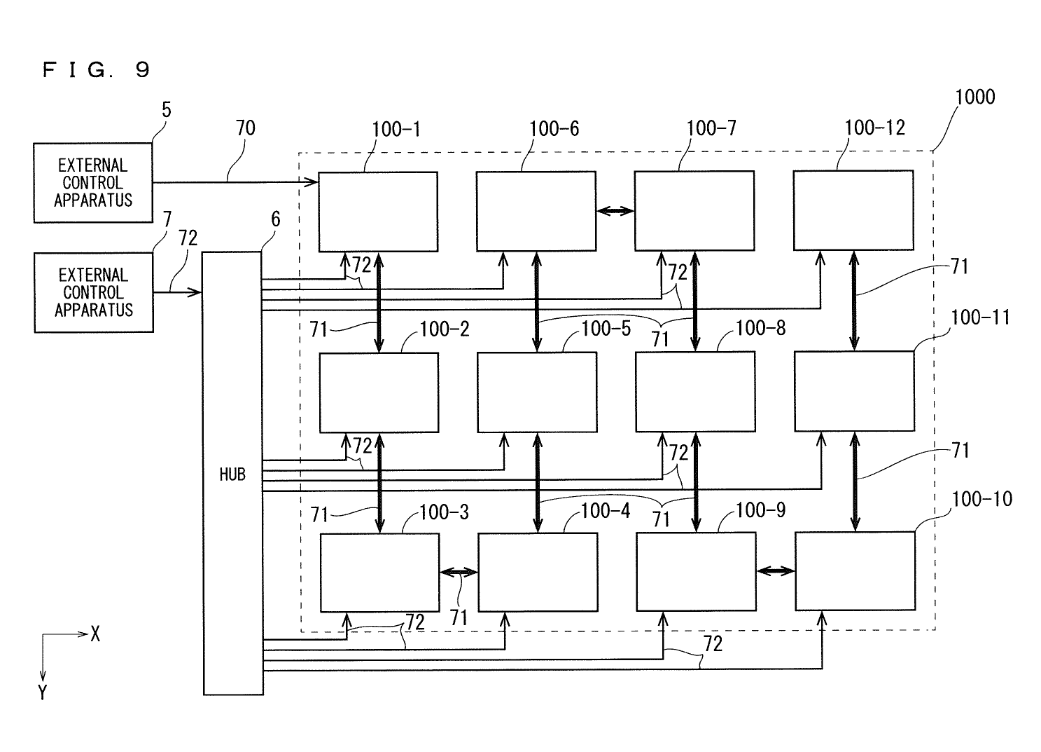

The configuration in which the individual video display apparatuses 100 corresponding to each column of the matrix MX corresponding to the plurality of video display apparatuses 100 arranged in matrix are connected to each other through the vertical connection cable is hereinafter referred to as “vertical connection configuration.” The vertical connection configuration is, for example, the cable connection configuration shown in FIG. 9. In the vertical connection configuration, the communication cables 71 connect the individual video display apparatuses 100 corresponding to each column of the matrix MX in the vertical direction (the Y axis direction).

In the vertical connection configuration, the video display apparatus 100 having the greatest sequence number among the video display apparatuses 100 corresponding to each column of the matrix MX is connected to another video display apparatus 100 adjacently located in the X direction through the communication cable 71 being the horizontal connection cable. For example, with reference to FIG. 9, the video display apparatus 100-3 having the sequence number 3 among the video display apparatuses 100 corresponding to the first column of the matrix MX is connected to the video display apparatus 100-4 adjacent to the video display apparatus 100-3 in the X direction through the communication cable 71 being the horizontal connection cable.

In the vertical connection configuration, the horizontal connection cables are located in different positions depending on the position of the reference video display apparatus (the master apparatus). In particular, in the vertical connection configuration, the horizontal connection cables are located in different positions depending on the position of the reference video display apparatus (the master apparatus), which is located in the upper-left end LT, the upper-right end RT, the lower-left end LB, or the lower-right end RB.

As an example, assume that the reference video display apparatus (the master apparatus) among the video display apparatuses 100 in the cable connection configuration in FIG. 9 is located in the upper-left end LT. In this case, for example, the horizontal connection cable is positioned so as to connect the video display apparatus 100-3 in the lower-left end LB to the video display apparatus 100-4 adjacent to the video display apparatus 100-3 in the X direction. In the vertical connection configuration of the above case, the individual video display apparatuses 100 are connected to each other through the communication cable 71 such that data is transmitted in the transmission sequence indicated by the arrows in part (b) in FIG. 8.

As an example, assume that the reference video display apparatus (the master apparatus) is located in the lower-left end LB in the vertical connection configuration. In this case, for example, the horizontal connection cable is positioned so as to connect the video display apparatus 100 in the upper-left end LT to another video display apparatus 100 adjacently located in the X direction.

Referring back to FIG. 6, in the wiring configuration input processing in Step S130, the operator inputs the wiring configuration information W to the external control apparatus 5, using the operation interface. The wiring configuration information W is, for example, the information specifying the horizontal connection configuration or the vertical connection configuration described above.

Then, the external control apparatus 5 sends, to the master apparatus, the wiring configuration information W that has been input. Only the master apparatus is set as the delivery target of the wiring configuration information W. Thus, the communication processing unit 33 of the master apparatus receives the wiring configuration information W from the external control terminal 34. Then, the communication processing unit 33 sends the wiring configuration information W only to the control unit 20. The control unit 20 causes the storing unit 32 to store the wiring configuration information W.

In Step S140, a position information input processing for inputting position information LJ is performed. The position information LJ is the information indicating the position of the master apparatus (the reference video display apparatus). The master apparatus (the reference video display apparatus) is located in any one of the upper-left end LT, the upper-right end RT, the lower-left end LB, and the lower-right end RB mentioned above.

In the position information input processing, the operator inputs the position information LJ to the external control apparatus 5, using the operation interface. The position information LJ is the information for specifying one of the upper-left end LT, the upper-right end RT, the lower-left end LB, and the lower-right RB. In a case where the master apparatus (the reference video display apparatus) is located in the upper-left end LT, the position information LJ to be input indicates the upper-left end LT.

Then, the external control apparatus 5 sends, to the master apparatus, the position information LJ that has been input. Only the master apparatus is set as the delivery target of the position information LJ. Thus, the communication processing unit 33 of the master apparatus receives the position information LJ from the external control terminal 34. Then, the communication processing unit 33 sends the position information LJ only to the control unit 20. The control unit 20 causes the storing unit 32 to store the position information LJ.

The rule for setting the identification numbers i being the identification information to the individual video display apparatuses 100 is hereinafter also referred to as “identification setting rule B” or “identification setting rule.” The identification setting rule B is the predetermined rule for setting the identification number i being the identification information to each of the video display apparatuses 100 included in the multiscreen display apparatus 1000. The identification setting rule B is defined to make it easier for the operator (a person) to recognize the identification number i.

In Step S150, an identification setting rule information input processing for inputting identification setting rule information R is performed. The identification setting rule information R is the information for specifying the identification setting rule B.

The video display apparatus 100 to which the identification number i is to be set is hereinafter also referred to as “setting target video display apparatus.” The video display apparatus 100 corresponding to the rightmost column of the matrix MX among the video display apparatuses 100 corresponding to each row of the matrix MX except the bottom row is hereinafter also referred to as “rightmost video display apparatus.” For example, with reference to FIG. 1, the rightmost video display apparatus corresponding to the first row of the matrix MX is the video display apparatus 100-4. The video display apparatus 100 corresponding to the leftmost column of the matrix MX among the video display apparatuses 100 corresponding to each row of the matrix MX except the first row is hereinafter also referred to as “leftmost video display apparatus.”

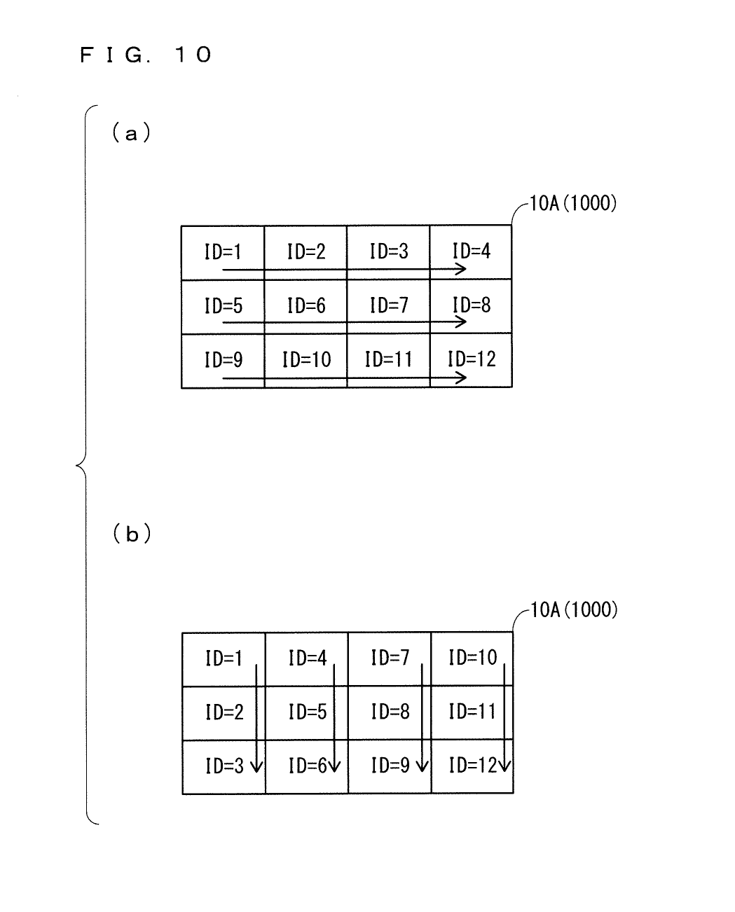

The identification setting rule for setting the identification numbers i, as shown in part (a) in FIG. 10, to the individual video display apparatuses 100 included in the multiscreen display apparatus 1000 is hereinafter also referred to as “horizontal setting rule.”

The position of the master apparatus (the reference video display apparatus) on the multiscreen 10A is hereinafter also referred to as “reference position BL.” The reference position BL is, for example, any one of the upper-left end LT, the upper-right end RT, the lower-left end LB, and the lower-right end RB in FIG. 7.

The raster scanning in which the sequence of scanning starting from the reference position BL is changed in the direction (the X axis direction) horizontal to the multiscreen 10A is hereinafter also referred to as “horizontal raster scanning.”

As an example, assume that the reference position BL is the upper-left end LT. In this case, the horizontal setting rule described above is defined on the basis of the sequence according to the horizontal raster scanning. That is, according to the horizontal setting rule, the value of the identification number i to be set is incremented by 1 every time the setting target video display apparatus shifts from one of the video display apparatuses 100 corresponding to each row of the matrix MX to another video display apparatus 100 sitting to the immediate right.

In particular, according to the horizontal setting rule, the value of the identification number i set to the video display apparatus 100 in the (HL+1)th column among the video display apparatuses 100 corresponding to each row of the matrix MX is greater by 1 than the value of the identification number i set to the video display apparatus 100 in the HL-th column. For example, as shown in part (a) in FIG. 10, the value of the identification number i set to the video display apparatus 100-2 in the second column among the video display apparatuses 100 corresponding to the first row of the matrix MX in FIG. 1 is 2, which is greater by 1 than the identification number i (1) set to the video display apparatus 100-1 in the first column.

According to the horizontal setting rule, the setting target video display apparatus to which the identification number i is to be set subsequent to the rightmost video display apparatus is the leftmost video display apparatus corresponding to the row next to the row of the matrix MX corresponding to the relevant rightmost video display apparatus. For example, according to the horizontal setting rule, the setting target video display apparatus to which the identification number i is to be set subsequent to the video display apparatus 100-4 corresponding to the first row of the matrix MX is the video display apparatus 100-8 corresponding to the second row of the matrix MX.

The video display apparatus 100 corresponding to the bottom row of the matrix MX among the video display apparatuses 100 corresponding to each column of the matrix MX except the rightmost column is hereinafter also referred to as “bottom video display apparatus.” For example, with reference to FIG. 9, the bottom video display apparatus corresponding to the first column of the matrix MX is the video display apparatus 100-3. The video display apparatus 100 corresponding to the top row of the matrix MX among the video display apparatuses 100 corresponding to each column of the matrix MX except the first column is hereinafter also referred to as “top video display apparatus.”

The identification setting rule for setting the identification numbers i, as shown in part (b) in FIG. 10, to the individual video display apparatuses 100 included in the multiscreen display apparatus 1000 is hereinafter also referred to as “vertical setting rule.” The raster scanning in which the sequence of scanning starting from the reference position BL is changed in the direction vertical to the multiscreen 10A is hereinafter also referred to as “vertical raster scanning.”

As an example, assume that the reference position BL is the upper-left end LT. In this case, the vertical setting rule is defined on the basis of the sequence according to the vertical raster scanning. That is, according to the vertical setting rule, the value of the identification number i to be set is incremented by 1 every time the setting target video display apparatus shifts from one of the video display apparatuses 100 corresponding to each column of the matrix MX to another video display apparatus 100 sitting immediately below.

In particular, according to the vertical setting rule, the value of the identification number i set to the video display apparatus 100 in the (VL+1)th row among the video display apparatuses 100 corresponding to each column of the matrix MX is greater by 1 than the value of the identification number i set to the video display apparatus 100 in the VL-th row. For example, with reference to FIG. 9, the value of the identification number i set to the video display apparatus 100-2 in the second row among the video display apparatuses 100 corresponding to the first column of the matrix MX is 2, which is greater by 1 than the identification number i (1) set to the video display apparatus 100-1 in the first row.

According to the vertical setting rule, the setting target video display apparatus to which the identification number i is to be set subsequent to the bottom video display apparatus is the top video display apparatus corresponding to the column next to the column of the matrix MX corresponding the above-mentioned bottom video display apparatus. For example, according to the vertical setting rule, the setting target video display apparatus to which the identification number i is to be set subsequent to the video display apparatus 100-3 corresponding to the first column of the matrix MX is the video display apparatus 100-6 corresponding to the second column of the matrix MX.

Referring back to FIG. 6, in the identification setting rule information input processing in Step S150, the operator inputs the identification setting rule information R to the external control apparatus 5, using the operation interface. The identification setting rule information R is the information for specifying, for example, the horizontal setting rule or the vertical setting rule.

Then, the external control apparatus 5 sends, to the master apparatus, the identification setting rule information R that has been input. Only the master apparatus is set as the delivery target of the identification setting rule information R. Thus, the communication processing unit 33 of the master apparatus receives the identification setting rule information R from the external control terminal 34. Then, the communication processing unit 33 sends the identification setting rule information R only to the control unit 20. The control unit 20 causes the storing unit 32 to store the identification setting rule information R.

In Step S160, the external control apparatus 5 sends an identification setting execution instruction M to the master apparatus (the video display apparatus 100-1). The identification setting execution instruction M is the instruction for causing the master apparatus to execute the processing (hereinafter also referred to as “identification information setting correspondence processing BM”) for setting the identification number i being the identification information. Only the master apparatus is the delivery target of the identification setting execution instruction M. That is, the identification setting execution instruction M is sent only to the master apparatus.

The master apparatus executes the identification information setting correspondence processing BM upon receipt of the identification setting execution instruction M. In particular, the communication processing unit 33 of the master apparatus receives the identification setting execution instruction M from the external control terminal 34. Then, the communication processing unit 33 sends the identification setting execution instruction M only to the control unit 20. Thus, the control unit 20 of the master apparatus receives the identification setting execution instruction M. The control unit 20 executes the identification information setting correspondence processing BM in accordance with the identification setting execution instruction M.

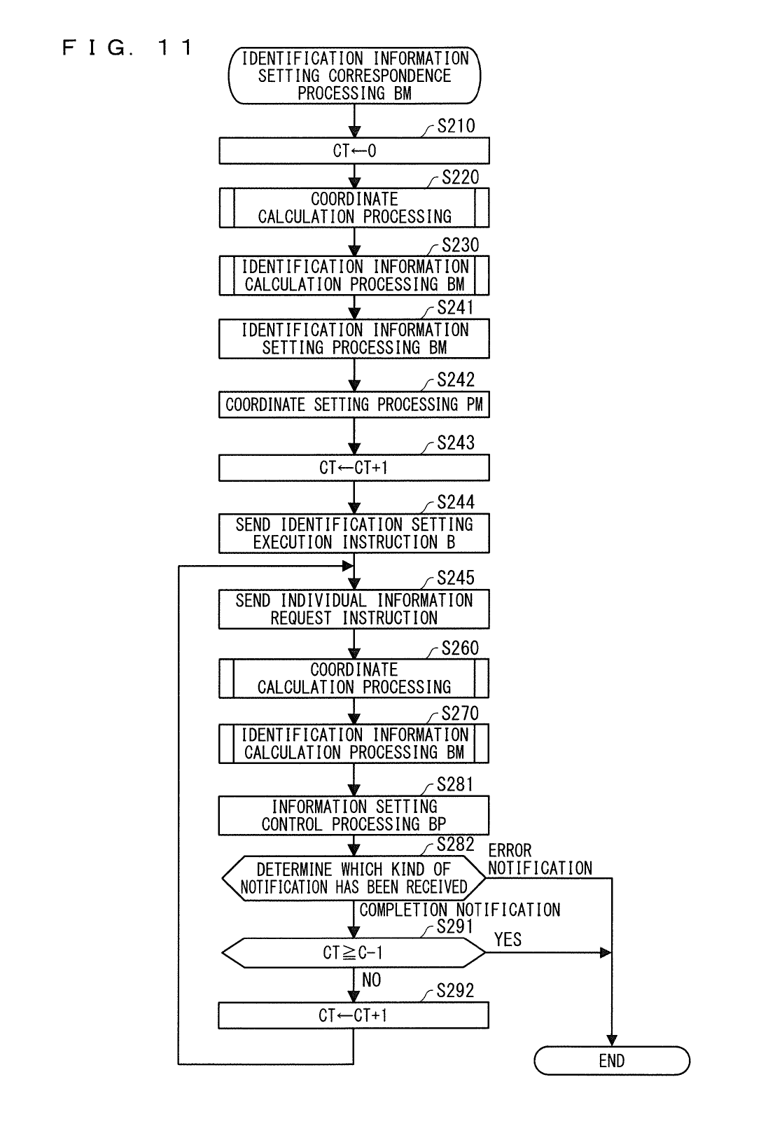

The following describes the identification information setting correspondence processing BM. FIG. 11 is a flowchart of the identification information setting correspondence processing BM. Firstly, the processing in Step S210 is performed in the identification information setting correspondence processing BM.

In Step S210, the calculating unit 21 (the control unit 20) sets the value of the counter CT at “0.” The counter CT is the internal counter in which numerical values are set in order to set the identification information. The counter CT is hereinafter also referred to simply as “CT.”

In Step S220, a coordinate calculation processing is performed. To sum up, in the coordinate calculation processing, the calculating unit 21 calculates the coordinates P (positions) of the plurality of video display apparatuses 100 included in the multiscreen display apparatus 1000 on the multiscreen 10A on the basis of the arrangement information KJ and the transmission sequence described above. To be a little more specific, the calculating unit 21 calculates the coordinates P on the basis of the position of the master apparatus being the reference video display apparatus.

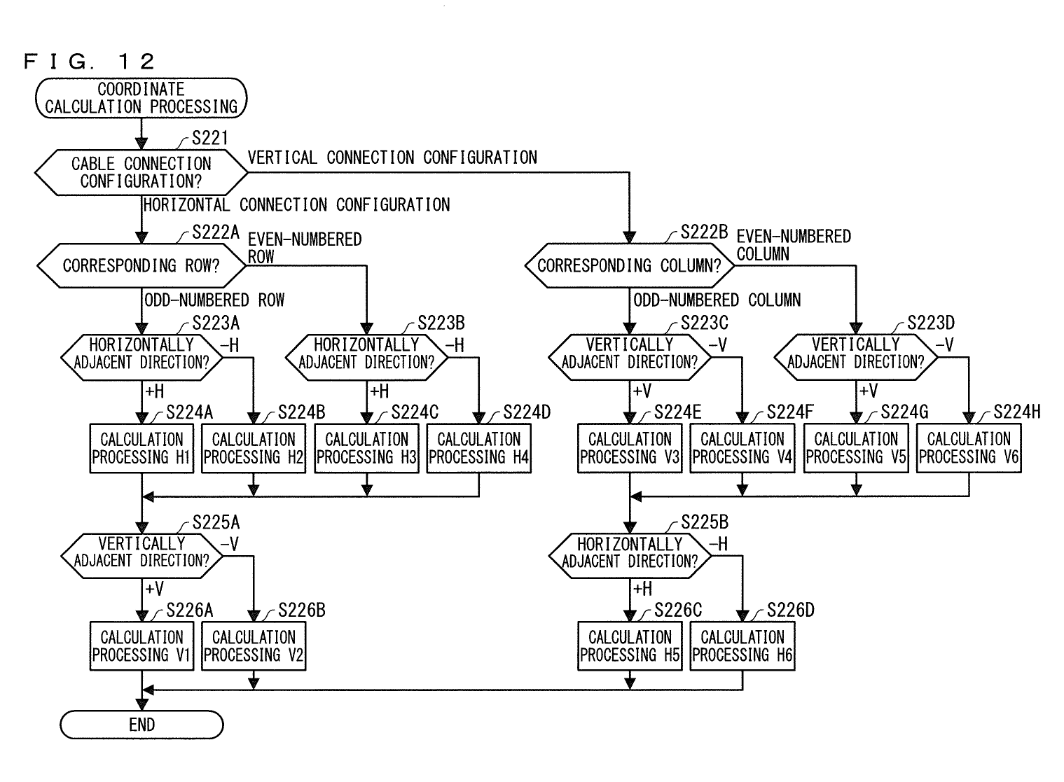

FIG. 12 is the flowchart of the coordinate calculation processing. The video display apparatus 100 whose coordinates are to be calculated in the coordinate calculation processing is hereinafter also referred to as “target apparatus PD.” The following firstly describes the processing for calculating the coordinates of the master apparatus in the coordinate calculation processing. Firstly, the processing in Step S221 is performed in the coordinate calculation processing.

In Step S221, the kind of cable connection configuration is determined. In particular, the calculating unit 21 (the control unit 20) determines whether the cable connection configuration is the horizontal connection configuration or the vertical connection configuration. To be more specific, the calculating unit 21 determines whether the wiring configuration information W stored in the storing unit 32 is the information specifying the horizontal connection configuration or the information specifying the vertical connection configuration.

If the cable connection configuration is the horizontal connection configuration, or equivalently, if the wiring configuration information W is the information specifying the horizontal connection configuration, the processing proceeds to Step S222A. Meanwhile, if the cable connection configuration is the vertical connection configuration, or equivalently, if the wiring configuration information W is the information specifying the vertical connection configuration, the processing proceeds to Step S222B.

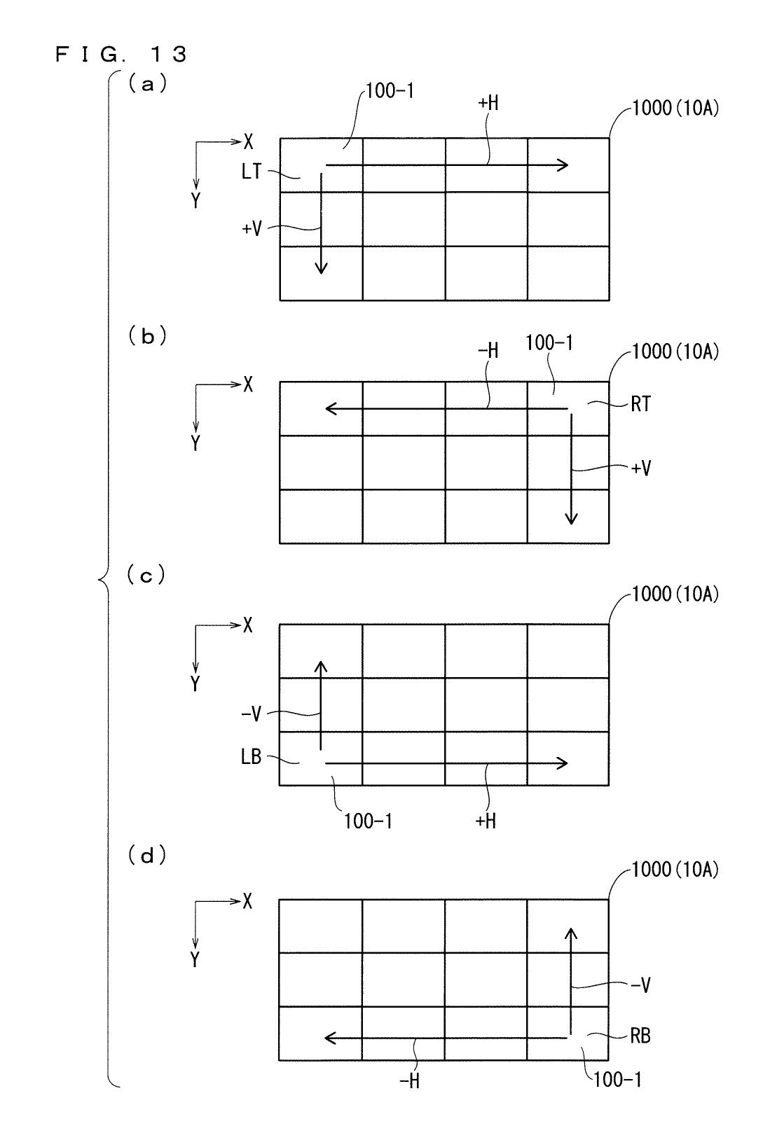

With reference to FIG. 13, the directions in the X-Y plane are defined as follows. Part (a) in FIG. 13 shows the arrangement configuration of the video display apparatuses 100 in the state where the master apparatus (the reference video display apparatus) is located in the upper-left end LT. Part (b) in FIG. 13 shows the arrangement configuration of the video display apparatuses 100 in the state where the master apparatus is located in the upper-right end RT. Part (c) in FIG. 13 shows the arrangement configuration of the video display apparatuses 100 in the state where the master apparatus is located in the lower-left end LB. Part (d) in FIG. 13 shows the arrangement configuration of the video display apparatuses 100 in the state where the master apparatus is located in the lower-right end RB.

The video display apparatus 100-2 that comes second in the transmission sequence is hereinafter also referred to as “second apparatus.” The second apparatus is connected to the master apparatus (the reference display apparatus) through the communication cable 71.

With reference to part (a) to part (d) in FIG. 13 to, the X direction in the X-Y plane is defined as “+H direction.” The −X direction in the X-Y plane is defined as “−H direction.” The Y direction in the X-Y plane is defined as “+V direction.” The −Y direction in the X-Y plane is defined as “−V direction.”

The video display apparatus 100 adjacent to the master apparatus (the reference video display apparatus) in the horizontal direction (the X axis direction) is hereinafter also referred to as “horizontally adjacent apparatus.” The video display apparatus 100 adjacent to the master apparatus in the vertical direction (the Y axis direction) is hereinafter also referred to as “vertically adjacent apparatus.” The direction tending from the master apparatus toward the horizontally adjacent apparatus is hereinafter also referred to as “horizontally adjacent direction.” The direction tending from the master apparatus toward the vertically adjacent apparatus is hereinafter also referred to as “vertically adjacent direction.”

The horizontally adjacent direction and the vertically adjacent direction are defined according to the position of the master apparatus. As an example, assume that the master apparatus is located in the upper-left end LT as shown in part (a) in FIG. 13. Also, assume that the cable connection configuration is the horizontal connection configuration.

In this case, as shown in FIG. 2, the horizontally adjacent apparatus is the video display apparatus 100-2 (the second apparatus) and the vertically adjacent apparatus is the video display apparatus 100-8. As shown in part (a) in FIG. 13, the horizontally adjacent direction is the +H direction and the vertically adjacent direction is +V direction. The master apparatus is connected to the second apparatus through the communication cable 71 being the horizontal connection cable.

As another example, assume that the master apparatus is located in the upper-left end LT as shown in part (a) in FIG. 13. Also, assume that the cable connection configuration is the vertical connection configuration. In this case, as shown in FIG. 9, the horizontally adjacent apparatus is the video display apparatus 100-6 and the vertically adjacent apparatus is the video display apparatus 100-2 (the second apparatus). As show in part (a) in FIG. 13, the master apparatus is connected to the second apparatus through the communication cable 71 being the vertical connection cable.

As another example, assume that the master apparatus is located in the upper-right end RT as shown in part (b) in FIG. 13. In this case, the horizontally adjacent direction is the −H direction and the vertically adjacent direction is the +V direction.

As another example, assume that the master apparatus is located in the lower-left end LB as shown in part (c) in FIG. 13. In this case, the horizontally adjacent direction is the +H direction and the vertically adjacent direction is the −V direction. As another example, assume that the master apparatus is located in the lower-right end RB as shown in part (d) in FIG. 13. In this case, the horizontally adjacent direction is the −H direction and the vertically adjacent direction is the −V direction.

In Step S222A, the calculating unit 21 (the control unit 20) determines whether the corresponding row is an odd-numbered row or an even-numbered row. The corresponding row is the row of the matrix MX corresponding to the target apparatus PD. The odd-numbered rows refer to the odd-numbered rows of the matrix MX with its origin being the position of the master apparatus (the reference video display apparatus). The even-numbered rows refer to the even-numbered rows of the matrix MX with its origin being the position of the master apparatus.

The following prerequisite A1 is reflected. Under the prerequisite A1, as an example, the individual video display apparatuses 100 are arranged as shown in FIG. 2. Under the prerequisite A1, the target apparatus PD is the video display apparatus 100-1. Under the prerequisite A1, assume that the master apparatus is located in the upper-left end LT.

Under the above-mentioned prerequisite A1, the first row of the matrix MX is the top row of the matrix corresponding to the configuration in FIG. 2. That is, the first row of the matrix MX is the row corresponding to, for example, the video display apparatuses 100-1 and 100-2. The row corresponding to the target apparatus PD is the first row of the matrix MX. The odd-numbered rows of the matrix MX corresponding to the prerequisite A1 are, for example, the row corresponding to the video display apparatuses 100-1 and the row corresponding to the video display apparatus 100-9. The even-numbered row of the matrix MX corresponding to the prerequisite A1 is, for example, the row corresponding to the video display apparatus 100-8. Thus, the row corresponding to the target apparatus PD under the prerequisite A1 is an odd-numbered TOW.

Then, the following prerequisite A2 is reflected. Under the prerequisite A2, as shown in FIG. 7, the twelve video display apparatuses 100 are arranged in a matrix, being the matrix MX, with three rows and four columns. Under the prerequisite A2, the target apparatus PD is the video display apparatus 100-1. Under the prerequisite A2, the master apparatus is located in the upper-right end RT.

Under the above-mentioned prerequisite A2, the first row of the matrix MX is the top row of the matrix MX corresponding to the configuration in FIG. 7. The row corresponding to the target apparatus PD is the first row of the matrix MX. The odd-numbered rows of the matrix MX corresponding to the prerequisite A2 are, for example, the row corresponding to the master apparatus and the row corresponding to the video display apparatus 100 located in the lower-left end LB. The even-numbered row of the matrix MX corresponding to the prerequisite A2 is, for example, the row corresponding to the video display apparatus 100 adjacent to the master apparatus in the Y direction. Thus, under the prerequisite A2, the row corresponding to the target apparatus PD is an odd-numbered row.

In Step S222A, whether the corresponding row is an odd-numbered row or an even-numbered row is calculated in the following way. In particular, the calculating unit 21 (the control unit 20) determines whether the corresponding row is an odd-numbered row or an even-numbered row using the up-to-date value of the counter CT and the horizontal number Hm stored in the storing unit 32.

The integer part of the value obtained by “CT/Hm” is defined as “determination value S.” Hm is the horizontal value Hm. As an example, assume that CT stands at 0 and Hm stands at 4. In this case, the determination value S stands at 0. As another example, assume that CT stands at 5 and Hm stands at 4. In this case, the determination value S is obtained by “5/4=1.25,” standing at 1. That is, the determination value S stands at 1, which is the integer part of 1.25.

The remainder of the expression “the determination value S/2” is defined as “row determination value Sa.” As an example, assume that the determination value S stands at 0. In this case, the row determination value Sa is obtained by “0/2,” standing at 0. That is, the row determination value Sa stands at 0, corresponding to the remainder of the division “0/2.” As another example, assume that the determination value S stands at 1. In this case, the row determination value Sa is obtained by “1/2,” standing at 1. That is, the row determination value Sa stands at 1, corresponding to the remainder of the division “1/2.” As still another example, assume that the determination value S stands at 2. In this case, the row determination value Sa is obtained by “2/2,” standing at 0. That is, the row determination value Sa stands at 0, corresponding to the remainder of the division “2/2.”

In a case where the row determination value Sa stands at 0, the calculating unit 21 determines that the row corresponding to the target apparatus PD is an odd-numbered row. In this case, the processing proceeds to the Step S223A. In a case where the row determination value Sa stands at 1, the calculating unit 21 determines that the row corresponding to the target apparatus PD is an even-numbered row. In this case, the processing proceeds to Step S223B.

In Step S223A, the calculating unit 21 (the control unit 20) determines whether the horizontally adjacent direction is the +H direction or the −H direction. The horizontally adjacent direction is defined according to the position of the master apparatus as described above with reference to FIG. 13. In a case where the horizontally adjacent direction is the +H direction, the processing proceeds to Step S224A. In a case where the horizontally adjacent direction is the −H direction, meanwhile, the processing proceeds to Step S224B.

The remainder of the expression “CT/Hm” is hereinafter defined as “MA.” As an example, assume that CT stands at 0 and Hm stands at 4. In this case, MA is obtained by “0/4,” standing at 0. That is, MA stands at 0, corresponding to the remainder of the division “0/4.” As another example, assume that CT stands at 5 and Hm stands at 4. In this case, MA is obtained by “5/4,” standing at 1. That is, MA stands at 1, corresponding to the remainder of the division “5/4.”

In Step S224A, the calculating unit 21 performs a calculation processing H1 for calculating the coordinate HL. In the calculation processing H1, the calculating unit 21 calculates the coordinate HL by the following expression (1).

HL=MA+1 Expression (1)

In Step S224B, the calculating unit 21 performs a calculation processing H2 for calculating the coordinate HL. In the calculation processing H2, the calculating unit 21 calculates the coordinate HL by the following expression (2).

HL=Hm−MA Expression (2)

In a case where the corresponding row is an even-numbered row in the above-described Step S222A, the processing proceeds to Step S223B.

In Step S223B, the same processing as the processing in the Step S223A is performed. In a case where the horizontally adjacent direction is the +H direction, the processing proceeds to Step S224C. In a case where the horizontally adjacent direction is the −H direction, meanwhile, the processing proceeds to Step S224D.

In Step S224C, the calculating unit 21 performs a calculation processing H3 for calculating the coordinate HL. In the calculation processing H3, the calculating unit 21 calculates the coordinate HL by the above-described expression (2).

In Step S224D, the calculating unit 21 performs a calculation processing H4 for calculating the coordinate HL. In the calculation processing H4, the calculating unit 21 calculates the coordinate HL by the above-described expression (1).

In Step S225A, the calculating unit 21 (the control unit 20) determines whether the vertically adjacent direction is the +V direction or the −V direction. The vertically adjacent direction is defined according to the position of the master apparatus as described above with reference to FIG. 13. In a case where the vertically adjacent direction is the +V direction, the processing proceeds to Step S226A. In a case where the vertically adjacent direction is the −V direction, meanwhile, the processing proceeds to Step S226B.

The determination value S described above is hereinafter also referred to as “MB.” The determination value S is the integer part of the value obtained by “CT/Hm.”

In Step S226A, the calculating unit 21 performs a calculation processing V1 for calculating the coordinate VL. In the calculation processing V2, the calculating unit 21 calculates the coordinate VL by the following expression (3).

VL=MB+1 Expression (3)

In Step S226B, the calculating unit 21 performs a calculation processing V2 for calculating the coordinate VL. In the calculation processing V2, the calculating unit 21 calculates the coordinate VL by the following expression (4).

VL=Vm−MB Expression (4)

The above-mentioned calculations provide the coordinates P (HL, VL) of the target apparatus PD in a case where the cable connection configuration is the horizontal connection configuration.

The following describes the procedures for calculation of the coordinates P (HL, VL) of the master apparatus under the following prerequisite B1. Under the prerequisite B1, CT stands at 0. Under the prerequisite B1, the twelve video display apparatuses 100 are arranged in a matrix, being the matrix MX, with three rows and four columns as shown in FIG. 2. Under the prerequisite B1, the master apparatus is located in the upper-left end LT. Thus, as shown in part (a) in FIG. 13, the horizontally adjacent direction is the +H direction and the vertically adjacent direction is the +V direction. Under the prerequisite B1, the horizontal number Hm stands at 4 and the vertical number Vm stands at 3. Under the prerequisite B1, the cable connection configuration is the horizontal connection configuration.

Under the prerequisite B1 described above, the processing in Step S221 is followed by the processing in Step S222A. Under the above-mentioned prerequisite B1, the determination value S that is the integer part of the value obtained by “CT/Hm” stands at 0. Thus, the row determination value Sa that is the remainder of the expression “the determination value S/2” stands at 0. The row determination value Sa stands at 0, and the calculating unit 21 therefore determines that, in Step S222A, the row corresponding to the master apparatus is an odd-numbered row.

Under the prerequisite B1, the horizontally adjacent direction is the +H direction, and thus, the processing in Step S223A is followed by the processing in Step S224A. The remainder MA of the expression “CT/Hm” stands at 0. The expression obtained by substitution of the value (MA=0) under the prerequisite B1 into the expression (1) in the calculation processing H1, or equivalently, “0+1=1” provides 1 as the coordinate HL.

Under the prerequisite B1, the vertically adjacent direction is the +V direction, and the processing in Step S226A is therefore performed. MB that is the integer part of the value obtained by “CT/Hm” stands at 0. The expression obtained by substitution of the value (MB=0) under the prerequisite B1 into the expression (3) in the calculation processing V1, or equivalently, “0+1=1” provides 1 as the coordinate VL. Thus, the calculations provide the coordinates P (1, 1) as the coordinates of the master apparatus.

Next, as another example, the following describes the procedures for calculation of the coordinates P (HL, VL) of the master apparatus under the prerequisite B2. The prerequisite B2 differs from the prerequisite B1 only in that the master apparatus is located in the upper-right end RT instead of being located in the upper-left end LT. The prerequisite B2 except for the above aspect is the same as the prerequisite B1. Under the prerequisite B2, the horizontally adjacent direction is the −H direction.

Under the prerequisite B2, the processing is performed, as in the processing under the prerequisite B1 described above, in the stated order of Steps S221, S222A, S223A, and S224B. The remainder MA of the expression “CT/Hm” stands at 0. The expression obtained by substitution of the values (Hm=4 and MA=0) under the prerequisite B2 into the expression (2) in the calculation processing H2, or equivalently, “4−0=4” provides 4 as the coordinate HL.

Then, as in the processing under the prerequisite B1, the processing in Steps S225A and S226A is performed, and thus, the calculations provide 1 as the coordinate VL. Thus, the calculations provide the coordinates P (4, 1) as the coordinates of the master apparatus.

Next, as another example, the following describes the procedures for calculating the coordinates P (HL, VL) under the prerequisite B3. The prerequisite B3 differs from the prerequisite B1 only in that the master apparatus is located in the lower-left end LB instead of being located in the upper-left end LT. The prerequisite B3 except for the above aspect is the same as the prerequisite B1. Under the prerequisite B3, the vertically adjacent direction is the −V direction.

Under the prerequisite B3, the processing is performed, as in the processing under the prerequisite B1 described above, in the stated order of Steps S221, S222A, S223A, S224B, S225A, and S226B. MB that is the integer part of the value obtained by the expression “CT/Hm” stands at 0. The expression obtained by substitution of the values (Vm=3 and MB=0) under the prerequisite B3 into the expression (4) in the calculation processing V2, or equivalently, “3−0=3” provides 3 as the coordinate VL. Thus, the calculations provide the coordinates P (1, 3) as the coordinates of the master apparatus.

The following describes the coordinate calculation processing in a case where the cable connection configuration is the vertical connection configuration. If the cable connection configuration is the vertical connection configuration, the processing having undergone Step S221 proceeds to Step S222B.

In Step S222B, the calculating unit 21 (the control unit 20) determines whether the corresponding column is an odd-numbered column or an even-numbered column. The corresponding column is the column of the matrix MX corresponding to the target apparatus PD. The odd-numbered columns refer to the odd-numbered columns of the matrix MX with its origin being the position of the master apparatus (the reference video display apparatus). The even-numbered columns refer to the even-numbered columns of the matrix MX with its origin being the position of the master apparatus.

The following prerequisite C1 is reflected. As an example, under the prerequisite C1, assume that the individual video display apparatuses 100 are arranged as shown in FIG. 9. Under the prerequisite C1, the target apparatus PD is the video display apparatus 100-1. Under the prerequisite C1, assume that the master apparatus is located in the upper-left end LT.

Under the above-mentioned prerequisite C1, the first column of the matrix MX is the leftmost column of the matrix MX corresponding to the configuration in FIG. 9. That is, the first column of the matrix MX is the column corresponding to, for example, the video display apparatuses 100-1 and 100-2. The column corresponding to the target apparatus PD is the first column of the matrix MX. The odd-numbered columns of the matrix MX corresponding to the prerequisite C1 are, for example, the column corresponding to the video display apparatus 100-1 and the column corresponding to the video display apparatus 100-7. The even-numbered columns of the matrix MX corresponding to the prerequisite C1 are, for example, the column corresponding to the video display apparatus 100-6 and the column corresponding to the video display apparatus 100-12. Thus, the column corresponding to the target apparatus PD under the prerequisite C1 is an odd-numbered column.

Then, the following prerequisite C2 is reflected. Under the prerequisite C2, as shown in FIG. 7, the twelve video display apparatuses 100 are arranged in a matrix, being the matrix MX, with three rows and four columns. Under the prerequisite C2, the target apparatus PD is the video display apparatus 100-1. Under the prerequisite C2, the master apparatus is located in the upper-right end RT.

Under the above-mentioned prerequisite C2, the first column of the matrix MX is the rightmost column of the matrix MX corresponding to the configuration in FIG. 7. The column corresponding to the target apparatus PD is the first column of the matrix MX. The odd-numbered columns of the matrix MX corresponding to the prerequisite C2 are, for example, the column corresponding to the master apparatus and the column corresponding to the video display apparatus 100 adjacent to another video display apparatus 100 located in the upper-left end LT in the X direction. The even-numbered columns of the matrix MX corresponding to the prerequisite C2 are, for example, the column corresponding to the video display apparatus 100 adjacent to the master apparatus in the −X direction and the column corresponding to the video display apparatus 100 located in the upper-left end LT. Thus, under the prerequisite C2, the column corresponding to the target apparatus PD is an odd-numbered column.

In Step S222B, whether the corresponding column is an odd-numbered column or an even-numbered column is calculated in the following way. In particular, the calculating unit 21 (the control unit 20) determines whether the corresponding column is an odd-numbered column or an even-numbered column using the up-to-date value of the counter CT and the vertical number Vm stored in the storing unit 32.

The integer part of the value obtained by “CT/Vm” is defined as “determination value T.” Vm is the vertical value Vm. As an example, assume that CT stands at 0 and Vm stands at 3. In this case, the determination value T stands at 0. As another example, assume that CT stands at 5 and Vm stands at 3. In this case, the determination value T is obtained by “5/3=1.67,” standing at 1. That is, the determination value T stands at 1, which is the integer part of 1.67.

The remainder of the expression “the determination value T/2” is defined as “column determination value Ta.” As an example, assume that the determination value T stands at 0. In this case, the column determination value Ta is obtained by “0/2,” standing at 0. That is, the column determination value Ta stands at 0, corresponding to the remainder of the division “0/2.” As another example, assume that the determination value T stands at 1. In this case, the column determination value Ta is obtained by “1/2,” standing at 1. That is, the column determination value Ta stands at 1, corresponding to the remainder of the division “1/2.” As still another example, assume that the determination value T stands at 2. In this case, the column determination value Ta is obtained by “2/2,” standing at 0. That is, the column determination value Ta stands at 0, corresponding to the remainder of the division “2/2.”

In a case where the column determination value Ta stands at 0, the calculating unit 21 determines that the column corresponding to the target apparatus PD is an odd-numbered column. In this case, the processing proceeds to the Step S223C. In a case where the column determination value Ta stands at 1, the calculating unit 21 determines that the column corresponding to the target apparatus PD is an even-numbered column. In this case, the processing proceeds to Step S223D.

In Step S223C, the same processing as the processing in Step S225A is performed, and the detailed description thereof is omitted. In a case where the vertically adjacent direction is the +V direction, the processing proceeds to Step S224E. In a case where the vertically adjacent direction is the −V direction, meanwhile, the processing proceeds to Step S224F.

The remainder of the expression “CT/Vm” is hereinafter defined as “MC.” As an example, assume that CT stands at 0 and Vm stands at 3. In this case, MC is obtained by “0/3,” standing at 0. That is, MC stands at 0, corresponding to the remainder of the division “0/3.” As another example, assume that CT stands at 5 and Vm stands at 4. In this case, MC is obtained by “5/4,” standing at 1. That is, MC stands at 1, corresponding to the remainder of the division “5/4.”

In Step S224E, the calculating unit 21 performs a calculation processing V3 for calculating the coordinate VL. In the calculation processing V3, the calculating unit 21 calculates the coordinate VL by the following expression (5).

VL=MC+1 Expression (5)

In Step S224F, the calculating unit 21 performs a calculation processing V4 for calculating the coordinate VL. In the calculation processing V4, the calculating unit 21 calculates the coordinate VL by the following expression (6).

VL=Vm−MC Expression (6)

In a case where the corresponding column is an even-numbered column in the above-described Step S222B, the processing proceeds to Step S223D.

In Step S223D, the same processing as the processing in Step S225A is performed, and the detailed description thereof is omitted. In a case where the vertically adjacent direction is the +V direction, the processing proceeds to Step S224G. In a case where the vertically adjacent direction is the −V direction, meanwhile, the processing proceeds to Step S224H.

In Step S224G, the calculating unit 21 performs a calculation processing V5 for calculating the coordinate VL. In the calculation processing V5, the calculating unit 21 calculates the coordinate VL by the above-described expression (6).

In Step S224H, the calculating unit 21 performs a calculation processing V6 for calculating the coordinate VL. In the calculation processing V6, the calculating unit 21 calculates the coordinate VL by the above-described expression (5).

In Step S225B, the same processing as the processing in the above-described Step S223A is performed, and the detailed description thereof is omitted. In a case where the horizontally adjacent direction is the +H direction, the processing proceeds to Step S226C. In a case where the horizontally adjacent direction is the −H direction, meanwhile, the processing proceeds to Step S226D.

The determination value T described above is hereinafter also referred to as “MD.” The determination value T is the integer part of the value obtained by “CT/Vm.”

In Step S226C, the calculating unit 21 performs a calculation processing H5 for calculating the coordinate HL. In the calculation processing H5, the calculating unit 21 calculates the coordinate HL by the following expression (7).

HL=MD+1 Expression (7)

In Step S226D, the calculating unit 21 performs a calculation processing H6 for calculating the coordinate HL. In the calculation processing H6, the calculating unit 21 calculates the coordinate HL by the following expression (8).

HL=Hm−MD Expression (8)

The above-mentioned calculations provide the coordinates P (HL, VL) of the target apparatus PD in a case where the cable connection configuration is the vertical connection configuration.

The following describes the procedures for calculation of the coordinates P (HL, VL) of the master apparatus under the following prerequisite D1. Under the prerequisite D1, CT stands at 0. Under the prerequisite D1, the twelve video display apparatuses 100 are arranged in a matrix, being the matrix MX, with three rows and four columns as shown in FIG. 9. Under the prerequisite D1, the master apparatus is located in the upper-left end LT. Thus, as shown in part (a) in FIG. 13, the horizontally adjacent direction is the +H direction and the vertically adjacent direction is the +V direction. Under the prerequisite D1, the horizontal number Hm stands at 4 and the vertical number Vm stands at 3. Under the prerequisite D1, the cable connection configuration is the vertical connection configuration.

Under the prerequisite D1 described above, the processing in Step S221 is followed by the processing in Step S222B. Under the above-mentioned prerequisite D1, the determination value T that is the integer part of the value obtained by “CT/Vm” stands at 0. Thus, the column determination value Ta that is the remainder of the expression “the determination value T/2” stands at 0. The column determination value Ta stands at 0, and the calculating unit 21 therefore determines that, in Step S222B, the column corresponding to the master apparatus is an odd-numbered column.

Under the prerequisite D1, the vertically adjacent direction is the +V direction, and thus, the processing in Step S223C is followed by the processing in Step 224E. MC obtained by the expression “CT/Vm” stands at 0. The expression obtained by substitution of the value (MC=0) under the prerequisite D1 into the expression (5) in the calculation processing V3, or equivalently, “0+1=1” provides 1 as the coordinate VL.

Under the prerequisite D1, the horizontally adjacent direction is the +H direction, and the processing in Step S226C is therefore performed. MD that is the integer part of the value obtained by “CT/Vm” stands at 0. The expression obtained by substitution of the value (MD=0) under the prerequisite D1 into the expression (7) in the calculation processing H5, or equivalently, “0+1=1” provides 1 as the coordinate HL. Thus, the calculations provide the coordinates P (1, 1) as the coordinates of the master apparatus.

Next, as another example, the following describes the procedures for calculation of the coordinates P (HL, VL) of the master apparatus under the prerequisite D2. The prerequisite D2 differs from the prerequisite D1 only in that the master apparatus is located in the upper-right end RT instead of being located in the upper-left end LT. The prerequisite D2 except for the above aspect is the same as the prerequisite D1. Under the prerequisite D2, the horizontally adjacent direction is the −H direction.

Under the prerequisite D2, the processing is performed, as in the processing under the prerequisite D1 described above, in the stated order of Steps S221, S222B, S223C, S224E, S225B, and S226D. The integer part MD of the value obtained by the expression “CT/Vm” stands at 0. The expression obtained by substitution of the values (Hm=4 and MD=0) under the prerequisite D2 into the expression (8) in the calculation processing H6, or equivalently, “4−0=4” provides 4 as the coordinate HL. Thus, the calculations provide the coordinates P (4, 1) as the coordinates of the master apparatus.

Next, as another example, the following describes the procedures for calculating the coordinates P (HL, VL) of the master apparatus under the prerequisite D3. The prerequisite D3 differs from the prerequisite D1 only in that the master apparatus is located in the lower-left end LB instead of being located in the upper-left end LT. The prerequisite D3 except for the above aspect is the same as the prerequisite D1. Under the prerequisite D3, the vertically adjacent direction is the −V direction.

Under the prerequisite D3, the processing is performed, as in the processing under the prerequisite D1 described above, in the stated order of Steps S221, S222B, S223C, and S224F. The remainder MC of the expression “CT/Vm” stands at 0. The expression obtained by substitution of the values (Vm=3 and MC=0) under the prerequisite D3 into the expression (6) in the calculation processing V4, or equivalently, “3−0=3” provides 3 as the coordinate VL.

Then, as in the processing under the above-described prerequisite D1, the processing in Steps S2258 and S226C are performed, and thus, the calculation provides 1 as the coordinate HL. The above-mentioned calculations provide the coordinates P (1, 3) as the coordinates of the master apparatus.

As described above, in the coordinate calculation processing, the calculating unit 21 calculates the coordinates P on the basis of the position of the master apparatus using any two of the expressions (1) to (8). After the coordinate calculation processing is ended, the processing returns to the identification information setting correspondence processing BM in FIG. 11 and the processing in Step S230 is performed.

In Step S230, an identification information calculation processing BM is performed. To sum up, in the identification information calculation processing BM, the calculating unit 21 calculates the identification number i being the identification information on the basis of the identification setting rule.

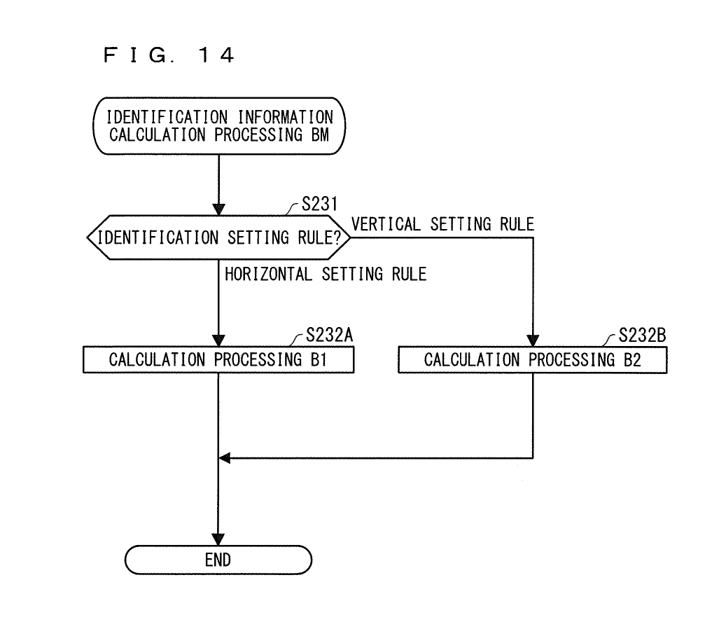

FIG. 14 is a flowchart of the identification information calculation processing BM. The video display apparatus 100 whose identification number i being the identification information is to be calculated in the identification information calculation processing BM is hereinafter also referred to as “target apparatus BD.” Firstly, the processing in Step S231 is performed in the identification information calculation processing BM.

In Step S231, the kind of identification setting rule is determined. In particular, the calculating unit 21 determines whether the identification setting rule is the horizontal setting rule or the vertical setting rule. To be more specific, the calculating unit 21 (the control unit 20) determines whether the identification setting rule information R stored in the storing unit 32 is the information specifying the horizontal setting rule or the information specifying the vertical setting rule.

If the identification setting rule is the horizontal setting rule, or equivalently, if the identification setting rule information R is the information specifying the horizontal setting rule, the processing proceeds to Step S232A. Meanwhile, if the identification setting rule is the vertical setting rule, or equivalently, if the identification setting rule information R is the information specifying the vertical setting rule, the processing proceeds to Step S232B.

In Step S232A, a calculation processing B1 for calculating the identification number i is performed. In the calculation processing B1, the calculating unit 21 calculates the identification number i by the following expression (9) using the calculated coordinates P (HL, VL), the horizontal number Hm, and the vertical number Vm.

i=HL+(VL−1)×Hm Expression (9)

In Step S232B, a calculation processing B2 for calculating the identification number i is performed. In the calculation processing B2, the calculating unit 21 calculates the identification number i by the following expression (10) using the calculated coordinates P (HL, VL).

i=(HL−1)×Vm+VL Expression (10)

The above-mentioned calculations provide the identification number i.

The following describes the procedures for calculation of the identification number i of the master apparatus under the following prerequisite E1. Under the prerequisite E1, the twelve video display apparatuses 100 are arranged in a matrix, being the matrix MX, with three rows and four columns as shown in FIG. 2. Under the prerequisite E1, the horizontal number Hm stands at 4 and the vertical number Vm stands at 3. Under the prerequisite E1, the master apparatus is located in the upper-left end LT. Under the prerequisite E1, the master apparatus has the coordinates (1, 1). Under the prerequisite E1, the identification setting rule is the horizontal setting rule.

Under the above-mentioned prerequisite E1, the processing is performed in the stated order of Steps S231 and S232A. In the calculation processing B1 in Step S232A, the calculating unit 21 provides 1 as the identification number i through the expression obtained by substitution of the values (HL=1, VL=1, and Hm=4) under the prerequisite E1 into the expression (9), or equivalently, “1+(1−1)×4=1.”

As another example, the following describes the procedures for calculation of the identification number i of the master apparatus under the prerequisite E2. The prerequisite E2 differs from the prerequisite E1 only in that the identification setting rule is the vertical setting rule. The prerequisite E2 except for the above aspect is the same as the prerequisite E1.

Under the prerequisite E2, the processing is performed in the stated order of Steps S231 and S232B. In the calculation processing B2 in Step S232B, the calculating unit 21 provides 1 as the identification number i through the expression obtained by substitution of the values (HL=1, Vm=3, and VL=1) under the prerequisite E2 into the expression (10), or equivalently, “(1−1)×3+1=1.”

As described above, in the identification information calculation processing BM, the calculating unit 21 calculates the identification number i being the identification information on the basis of the identification setting rule, using the expression (9) or the expression (10). After the identification information calculation processing BM is ended, the processing returns to the identification information setting correspondence processing BM in FIG. 11 and the processing in Step S241 is performed.

In Step S241, an identification information setting processing BM is performed. In the identification information setting processing BM, the setting unit 22 of the control unit 20 performs the processing for setting the identification number i of the video display apparatus (the master apparatus) with the calculated coordinates P to the video display apparatus (the master apparatus) concerned. In particular, the setting unit 22 causes the storing unit 32 to store the identification number i calculated in the identification information calculation processing BM. Consequently, the identification number is set to the master apparatus.

In Step S242, a coordinate setting processing PM is performed. In the coordinate setting processing PM, the setting unit 22 performs the processing for setting the coordinates P of the video display apparatus (the master apparatus) with the calculated coordinates P to the video display apparatus (the master apparatus) concerned. In particular, the setting unit 22 causes the storing unit 32 to store the coordinates P of the master apparatus calculated in the coordinate calculation processing. Consequently, the coordinates P are set to the master apparatus.

In Step S243, the calculating unit 21 (the control unit 20) increments the value of the counter CT by 1. Thus, the value of the counter CT stands at 1.

In Step S244, the control unit 20 sends an identification setting execution instruction B to all of the salve apparatuses. The identification setting execution instruction B is the instruction for causing the slave apparatus to set the identification number i being the identification information. In other words, the identification setting execution instruction B is the instruction for causing the slave apparatus to execute the processing (hereinafter also referred to as “identification information setting correspondence processing BS”) for setting the identification number i. The identification setting execution instruction B is also the instruction for shifting the operation mode of the slave apparatus to the identification setting mode.

In particular, the control unit 20 of the master apparatus sends the identification setting execution instruction B, with the set delivery targets being all of the slave apparatuses, to the slave apparatus (the video display apparatus 100-2) that comes second in the transmission sequence. The identification number i is indicated in the identification setting execution instruction B. As an example, assume that the number 9999 is set as the value of the identification number i. Thus, the identification setting execution instruction B is sent to all of the slave apparatuses through the communication channel SK according to the above-mentioned transmission sequence.

Consequently, the control unit 20 of each of the slave apparatuses receives the identification setting execution instruction B. In particular, the communication processing unit 33 receives the identification setting execution instruction B form the previous adjacent video display apparatus 100 (the master apparatus or the slave apparatus) through the input terminal 35a. The communication processing unit 33 sends the received identification setting execution instruction B to the control unit 20 and the output terminal 35b. The control unit 20 thus receives the identification setting execution instruction B.

The value of the identification number i indicated by the identification setting execution instruction B is not limited to 9999 and may be any number greater than the maximum value (for example, 100) that can be actually set as the identification number i.

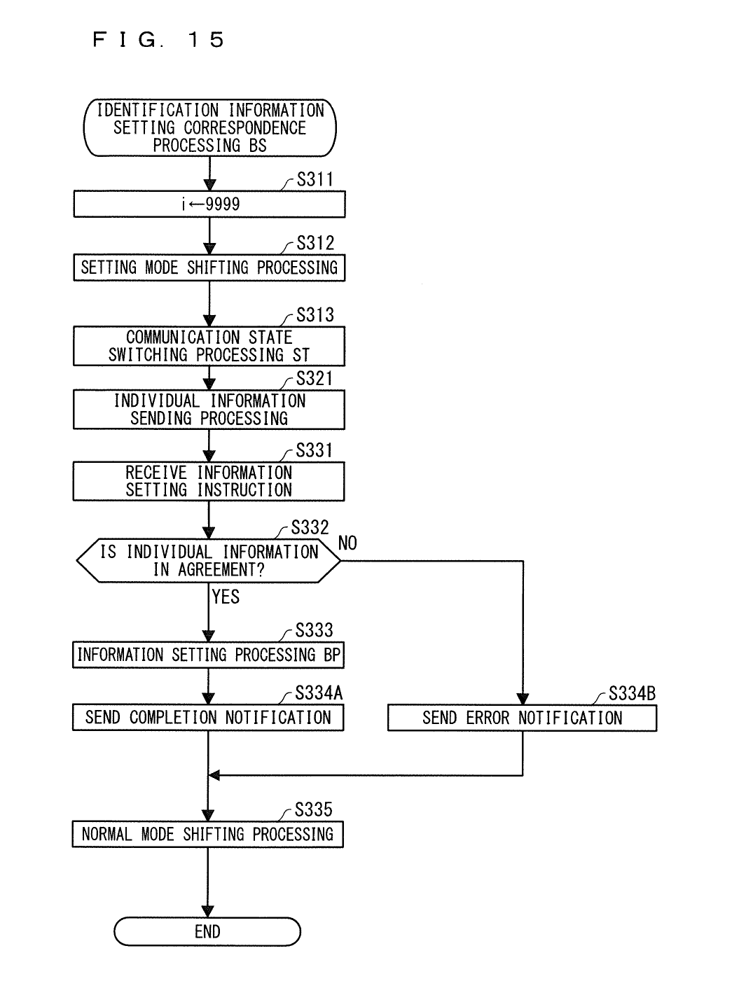

The control unit 20 of the individual salve apparatus executes the identification information setting correspondence processing BS upon receipt of the identification setting execution instruction B. FIG. 15 is a flowchart of the identification information setting correspondence processing BS. Firstly, the processing in Step S311 is performed in the identification information setting correspondence processing BS.

In Step S311, the identification number i is set to 9999. In particular, the control unit 20 causes the storing unit 32 to store the identification number i (9999) indicated by the received identification setting execution instruction B In Step S312, an setting mode shifting processing is performed. In the setting mode shifting processing, the control unit 20 shifts the operation mode of the salve apparatus from the above-mentioned normal mode to the identification setting mode in accordance with the identification setting execution instruction B.

In Step S313, a communication state switching processing ST is performed. In the communication state switching processing ST, the control unit 20 sets the state of the communication processing unit 33 to the upstream transfer suspension state. As described above, the communication processing unit 33 in the upstream transfer suspension state sends the data received by the output terminal 35b only to the control unit 20 and does not send the data to the input terminal 35a. The communication processing unit 33 in the upstream transfer suspension state sends (transfers) the data (signal) received by the input terminal 35a to the output terminal 35b.

In the master apparatus, the processing in Step S244 is followed by the Step S245. The slave apparatus having the identification number i set to 9999 is hereinafter also referred to as “target slave apparatus.”

In Step S245, the control unit 20 sends, to each of the target slave apparatuses, an individual information request instruction for requesting the individual information. The individual information is the information for identifying each of the salve apparatuses. The individual information includes, for example, serial numbers and MAC addresses. Each of the slave apparatuses has the distinctive individual information set thereto in advance.

Thus, the individual information request instruction is sent to all of the target slave apparatuses according to the above-mentioned transmission sequence.

Upon receipt of the individual information request instruction, the target slave apparatus performs the processing in Step S321.

In Step S321, an individual information sending processing is performed. In the individual information sending processing, the control unit 20 sends the individual information of the own apparatus (the slave apparatus) to the communication processing unit 33 such that the relevant individual information is transferred toward the master apparatus through the communication processing unit 33 and the input terminal 35a as well as the communication channel SK described above. The master apparatus is set as the delivery target of the individual information.

Unfortunately, as a result of the communication state switching processing ST described above, the state of the communication processing unit 33 is set to the upstream transfer suspension state. Thus, the communication processing unit 33 in the upstream transfer suspension state does not send the individual information received by the output terminal 35b to the input terminal 35a. In a case where the individual information sending processing is performed for the first time, the master apparatus receives the individual information of the video display apparatus 100-2 only form the video display apparatus 100-2.

The slave apparatus corresponding to the individual information received by the master apparatus is hereinafter also referred to as “response slave apparatus.” In a case where the individual information sending processing is performed for the first time, the response slave apparatus refers only to the video display apparatus 100-2.

Upon receipt of the individual information, the master apparatus performs the processing in Step S260. In Step S260, the coordinate calculation processing in FIG. 12 is performed. The coordinates P of the response salve apparatus are calculated through the coordinate calculation processing. The example of the calculation of the coordinates P of the response slave apparatus will be described later.

In Step S270, the identification information calculation processing BM in FIG. 14 is performed. The identification number i of the response salve apparatus is calculated through the identification information calculation processing BM. The example of the calculation of the identification number i of the response slave apparatus will be described later.

In Step S281, an information setting control processing BP is performed. The information setting control processing BP is the processing for setting, through the setting unit 22, the identification number i of the video display apparatus (the response slave apparatus) with the calculated coordinates P to the video display apparatus concerned. The information setting control processing BP is also the processing for setting, through the setting unit 22, the coordinates P of the video display apparatus (the response slave apparatus) with the calculated coordinates P to the video display apparatus (the response slave apparatus) concerned.

In particular, in the information setting control processing BP, the setting unit 22 sends the information setting instruction to the response salve apparatus. The information setting instruction is the instruction for setting the calculated identification number i and the calculated coordinates P of the response slave apparatus to the response slave apparatus. The information setting instruction indicates the identification number i and the coordinates P of the response salve apparatus concerned. The information setting instruction also indicates the individual information of the response slave apparatus received by the master apparatus.

In the response slave apparatus, the control unit 20 receives the information setting instruction in Step S331.

In Step S332, the control unit 20 determines whether the individual information of the own apparatus (the response slave apparatus) agrees with the individual information indicated by the received information setting instruction. If Step S332 results in YES, the processing proceeds to Step S333. If Step S332 results in NO, the processing proceeds to Step S334B.

In Step S333, an information setting processing BP is performed. In the information setting processing BP, the setting unit 22 sets the identification number i indicated by the received information setting instruction to the own apparatus (the response slave apparatus). In particular, the setting unit 22 changes the value (9999) of the identification number i stored in the storing unit 32 to the value of the identification number i indicated by the information setting instruction.

The setting unit 22 sets the coordinates P indicated by the received information setting instruction to the own apparatus (the response salve apparatus). In particular, the setting unit 22 causes the storing unit 32 to store the coordinates P indicated by the information setting instruction.

In Step S334A, the control unit 20 (the setting unit 22) sends a completion notification to the master apparatus. The completion notification is the notification that the setting of the identification number and the coordinates has been completed.

In Step S335, a normal mode shifting processing is performed. In the normal mode shifting processing, the control unit 20 shifts the operation mode of the video display apparatus 100 from the identification setting mode to the normal mode. Along with this, the control unit 20 sets the state of the communication processing unit 33 to the normal state. That is, the upstream transfer suspension state of the communication processing 33 is canceled.

As described above, the communication processing unit 33 in the normal state sends (transfers) the data received by the output terminal 35b to the input terminal 35a. As described above, the communication processing unit 33 in the normal state sends the data received by the input terminal 35a or the output terminal 35b to the control unit 20. As described above, the communication processing unit 33 in the normal state sends the data (signal) received by the control unit 20 to the input terminal 35a or the output terminal 35b in accordance with the destination of the relevant data.

The normal mode shifting processing described above allows the video display apparatus 100-2 to send (transfer) the data received by the output terminal 35b to the input terminal 35a. The data sent to the input terminal 35a is sent to the previous video display apparatus 100 (the master apparatus) adjacent to the above-mentioned slave display apparatus. Then, the identification information setting correspondence processing BS is ended.

If Step S332 results in NO, the processing proceeds to Step S334B. In Step S334B, the control unit 20 (the setting unit 22) sends an error notification to the master apparatus.

Upon receipt of the completion notification or the error notification through the above-described processing, the master apparatus performs the processing in Step S282.

In Step S282, the control unit 20 determines which kind of notification has been received. If the control unit 20 receives the completion notification, the processing proceeds to Step S291. If the control unit 20 receives the error notification, the identification information setting correspondence processing BM is ended.

The number of the video display apparatuses 100 included in the multiscreen display apparatus 1000 is hereinafter also referred to as “constituent number C” or “C.” C is a natural number. In a case where the multiscreen display apparatus 1000 has the configuration in FIG. 2, the constituent number C stands at 12.

In Step S291, the control unit 20 determines whether the value of the counter CT is greater than or equal to the value obtained by the expression “C−1” or not. The constituent number C is calculated by the expression “the horizontal number Hm×the vertical number Vm.”

If Step S291 results in YES, the identification information setting correspondence processing BM is ended. For YES in Step S291, the setting of the coordinates P and the identification number i has been completed for all of the video display apparatuses 100 included in the multiscreen display apparatus 1000. For NO in Step S291, meanwhile, the processing proceeds to Step S292.

In Step S292, the calculating unit 21 increments the value of the counter CT by 1. Then, the processing in Step S245 is performed again.

In a case where the control unit 20 continuously fails to receive the error notification or the value of the counter CT continues to be less than “C−1” through the identification information setting correspondence processing BM described above, the processing in Steps S245 to S292 is repeatedly performed. Thus, Step S281 is repeatedly performed. Step S281 is repeatedly performed, so that the setting unit 22 performs the processing for setting the identification number i of each of the video display apparatuses (the response slave apparatuses) with the calculated coordinates P to the video display apparatus (the response salve apparatus) concerned. Step S281 is repeatedly performed, so that the setting unit 22 performs the processing for setting the coordinates P of each of the video display apparatuses (the response slave apparatuses) with the calculated coordinates P to the video display apparatus (the response salve apparatus) concerned.

Every time the processing in Steps S245 to S292 is performed, the number of the target slave apparatuses decreases. For example, the target slave apparatuses at the end of the first round of the processing in Steps S245 to S292 are the video display apparatuses 100-3, 100-4, 100-5, 100-6, 100-7, 100-8, 100-9, 100-10, 100-11, and 100-12.

Every time the processing in Steps S245 to S292 is performed, a processing A described below is performed. In the processing A, the individual information request instruction is sent to each of the target slave apparatuses through Step S245. In the processing A, upon receipt of the individual information request instruction, the target slave apparatuses perform the processing in Step S321.

For example, in a case where the second round of the processing in Step S245 is performed, the master apparatus receives the individual information of the video display apparatus 100-3 only from the video display apparatus 100-3. In this case, the response slave apparatus refers only to the video display apparatus 100-3. In this case, the value of the counter CT used to calculate the coordinates P and the identification number i of the video display apparatus 100-3 stands at 2.

That is, through the identification information setting correspondence processing BM described above, the master apparatus increments the value of the counter CT, and along with the incrimination, sets the coordinates P and the identification number i to each of the slave apparatuses according to the transmission sequence.

If “CT=C−1” is satisfied (YES in Step S291), the master apparatus determines that the setting of the identification number i has been completed for the video display apparatuses including the terminal video display apparatus mentioned above, and the identification information setting correspondence processing BM is ended.

The following describes the procedures for calculation of the coordinates P and the identification numbers i of the slave apparatuses. The salve apparatus whose coordinates P and identification number i are to be calculated is hereinafter also referred to as “calculation target slave apparatus.” Firstly, the following describes the procedures for calculating the coordinates P and the identification number i of the calculation target slave apparatus under the following prerequisite F1.

Under the prerequisite F1, the twelve video display apparatuses 100 are arranged in a matrix, being the matrix MX, with three rows and four columns as shown in FIG. 2. Under the prerequisite F1, the calculation target slave apparatus is the video display apparatus 100-6. Under the prerequisite F1, CT stands at 5. Under the prerequisite F1, the horizontal number Hm stands at 4 and the vertical number Vm stands at 3. Under the prerequisite F1, the master apparatus is located in the upper-left end LT. Thus, as shown in part (a) in FIG. 13, the horizontally adjacent direction is the +H direction and the vertically adjacent direction is the +V direction. Under the prerequisite F1, the cable connection configuration is the horizontal connection configuration. Under the prerequisite F1, the identification setting rule is the horizontal setting rule.

Firstly, the following describes the procedures for calculation of the coordinates P of the under the following prerequisite F1. With reference to FIG. 12, the processing in Step S221 is followed by the processing in Step S222A under the prerequisite F1.

In Step S222A, under the above-mentioned prerequisite F1, the determination value S that is the integer part of the value given by “CT/Hm” is obtained by 5/4=1.25, standing at 1. Thus, the row determination value Sa that is the remainder of the expression “the determination value S/2” is obtained by 1/2, standing at 1. The row determination value Sa stands at 1, and the calculating unit 21 therefore determines that the row corresponding to the calculation target slave apparatus is an even-numbered row.

Thus, the processing proceeds to Step S223B. Under the prerequisite F1, the horizontally adjacent direction is the +H direction, and thus, the processing in Step S223B is followed by the processing in Step S224C. The remainder MA of the expression “CT/Hm” is obtained by 5/4, standing at 1. The expression obtained by substitution of the values (Hm=4 and MA=1) under the prerequisite F1 into the expression (2) in the calculation processing H3, or equivalently, “4−1=3” provides 3 as the coordinate HL.

Under the prerequisite F1, the vertically adjacent direction is the +V direction, and the processing in Step S226A is therefore performed. MB that is the integer part of the value given by “CT/Hm” is obtained by 5/4=1.25, standing at 1. The expression obtained by substitution of the value (MB=1) under the prerequisite F1 into the expression (3) in the calculation processing V1, or equivalently, “1+1=2” provides 2 as the coordinate VL. Thus, the calculations provide the coordinates P (3, 2) as the coordinates of the video display apparatus 100-6 being the slave apparatus under the prerequisite F1.

Next, the following describes the procedures for calculation of the identification number i under the prerequisite F1. Under the prerequisite F1, the identification setting rule is the horizontal setting rule, and thus, the processing is performed in the stated order of Steps S231 and S232A in FIG. 14. In the calculation processing B1 in Step S232A, the calculating unit 21 provides 7 as the identification number i through the expression obtained by substitution of the values (HL=3, VL=2, and Hm=4) under the prerequisite F1 into the expression (9), or equivalently, “3+(2−1)×4=7.”

Next, as another example, the following describes the procedures for calculation of the coordinates P and the identification number i of the calculation target slave apparatus under the prerequisite F2. The prerequisite F2 differs from the prerequisite F1 only in that the master apparatus is located in the upper-right end RT instead of being located in the upper-left end LT. The prerequisite F2 except for the above aspect is the same as the prerequisite F1. Under the prerequisite F2, the horizontally adjacent direction is the −H direction.

Under the prerequisite F2, the processing is performed, as in the processing under the prerequisite F1 described above, in the stated order of Steps S221, S222A, S223B, and S224D in FIG. 12. The remainder MA of the expression “CT/Hm” stands at 1. The expression obtained by substitution of the value (MA=1) under the prerequisite F2 into the expression (1) in the calculation processing H4, or equivalently, “1+1=2” provides 2 as the coordinate HL.

Then, as in the processing under the prerequisite F1, the processing in Steps S225A and S226A is performed, and thus, the calculations provide 2 as the coordinate VL. Thus, the calculations provide the coordinates P (2, 2) as the coordinates of the video display apparatus 100-6 being the slave apparatus under the prerequisite F2.

Next, the following describes the procedures for calculation of the identification number i under the prerequisite F2. Under the prerequisite F2, the identification setting rule is the horizontal setting rule, and thus, the processing is performed in the stated order of Steps S231 and S232A in FIG. 14. In the calculation processing B1 in Step S232A, the calculating unit 21 provides 6 as the identification number i through the expression obtained by substitution of the values (HL=2, VL=2, and Hm=4) under the prerequisite F2 into the expression (9), or equivalently, “2+(2−1)×4=6.”

As another example, the following describes the procedures for calculation of the coordinates P and the identification number i of the calculation target slave apparatus under the prerequisite F3. The prerequisite F3 differs from the prerequisite F1 only in that the calculation target slave apparatus is the video display apparatus 100-9. The prerequisite F3 except for the above aspect is the same as the prerequisite F1. Under the prerequisite F3, CT stands at 8.

Under the prerequisite F3, the processing in Step S221 is followed by the processing in Step S222A in FIG. 12.

In Step S222A, under the above-mentioned prerequisite F3, the determination value S that is the integer part of the value given by “CT/Hm” is obtained by 8/4=2, standing at 2. Thus, the row determination value Sa that is the remainder of the expression “the determination value S/2” is obtained by 2/2, standing at 0. The row determination value Sa stands at 0, and the calculating unit 21 therefore determines that the row corresponding to the calculation target slave apparatus is an odd-numbered row.

Thus, the processing proceeds to Step S223A. Under the prerequisite F3, the horizontally adjacent direction is the +H direction, and thus, the processing in Step S223A is followed by the processing in Step S224A. The remainder MA of the expression “CT/Hm” is obtained by 8/4, standing at 0. The expression obtained by substitution of the value (MA=0) under the prerequisite F3 into the expression (1) in the calculation processing H1, or equivalently, “0+1=1” provides 1 as the coordinate HL.

Under the prerequisite F3, the vertically adjacent direction is the +V direction, and the processing in Step S226A is therefore performed. MB that is the integer part of the value given by the expression “CT/Hm” is obtained by 8/4=2, standing at 2. The expression obtained by substitution of the value (MB=2) under the prerequisite F3 into the expression (3) in the calculation processing V1, or equivalently, “2+1=3” provides 3 as the coordinate VL. Thus, the calculations provide the coordinates P (1, 3) as the coordinates of the video display apparatus 100-9 being the salve apparatus under the prerequisite F3.

Next, the following describes the procedures for calculation of the identification number i under the prerequisite F3. Under the prerequisite F3, the identification setting rule is the horizontal setting rule, and thus, the processing is performed in the stated order of Steps S231 and S232A in FIG. 14. In the calculation processing B1 in Step S232A, the calculating unit 21 provides 9 as the identification number i through the expression obtained by substitution of the values (HL=1, VL=3, and Hm=4) under the prerequisite F3 into the expression (9), or equivalently, “1+(3−1)×4=9.”

Next, as another example, the following describes the procedures for calculation of the coordinates P and the identification number i of the calculation target slave apparatus under the prerequisite F4.

Under the prerequisite F4, the twelve video display apparatuses 100 are arranged in a matrix, being the matrix MX, with three rows and four columns as shown in FIG. 9. Under the prerequisite F4, the calculation target slave apparatus is the video display apparatus 100-10. Under the prerequisite F4, CT stands at 9. Under the prerequisite F4, the horizontal number Hm stands at 4 and the vertical number Vm stands at 3. Under the prerequisite F4, the master apparatus is located in the upper-left end LT. Thus, as shown in part (a) in FIG. 13, the horizontally adjacent direction is the +H direction and the vertically adjacent direction is the +V direction. Under the prerequisite F4, the cable connection configuration is the vertical connection configuration. Under the prerequisite F4, the identification setting rule is the horizontal setting rule.

Under the prerequisite F4, the processing in Step S221 is followed by the processing in Step S222B in FIG. 12.

In Step S222B, under the above-mentioned prerequisite F4, the determination value T that is the integer part of the value given by “CT/Vm” is obtained by 9/3=3, standing at 3. Thus, the column determination value Ta that is the remainder of the expression “the determination value T/2” is obtained by 3/2, standing at 1. The column determination value Ta stands at 1, and the calculating unit 21 therefore determines that the column corresponding to the calculation target slave apparatus is an odd-numbered column.

Thus, the processing proceeds to Step S223D. Under the prerequisite F4, the vertically adjacent direction is the +V direction, and thus, the processing in Step S223D is followed by the processing in Step S224G. The remainder MC of the expression “CT/Vm” is obtained by 9/3, standing at 0. The expression obtained by substitution of the values (Vm=3 and MC=0) under the prerequisite F4 into the expression (6) in the calculation processing V5, or equivalently, “3−0=3” provides 3 as the coordinate VL.

Under the prerequisite F4, the horizontally adjacent direction is the +H direction, and the processing in Step S226C is therefore performed. MD that is the integer part of the value given by the expression “CT/Vm” is obtained by 9/3=3, standing at 3. The expression obtained by substitution of the value (MD=3) under the prerequisite F4 into the expression (7) in the calculation processing H5, or equivalently, “3+1=4” provides 4 as the coordinate HL. Thus, the calculations provide the coordinates P (4, 3) as the coordinates of the video display apparatus 100-10 being the salve apparatus under the prerequisite F4.

Next, the following describes the procedures for calculation of the identification number i under the prerequisite F4. Under the prerequisite F4, the identification setting rule is the horizontal setting rule, and thus, the processing is performed in the stated order of Steps S231 and S232A in FIG. 14. In the calculation processing B1 in Step S232A, the calculating unit 21 provides 12 as the identification number i through the expression obtained by substitution of the values (HL=4, VL=3, and Hm=4) under the prerequisite F4 into the expression (9), or equivalently, “4+(3−1)×4=12.”

As another example, the following describes the procedures for calculation of the coordinates P and the identification number i of the calculation target slave apparatus under the prerequisite F5. The prerequisite F5 differs from the prerequisite F4 only in that the calculation target slave apparatus is the video display apparatus 100-7. The prerequisite F5 except for the above aspect is the same as the prerequisite F4. Under the prerequisite F5, CT stands at 6.

Under the prerequisite F5, the processing in Step S221 is followed by the processing in Step S222B in FIG. 12.

In Step S222B, under the above-mentioned prerequisite F5, the determination value T that is the integer part of the value given by “CT/Vm” is obtained by 6/3=2, standing at 2. Thus, the column determination value Ta that is the remainder of the expression “the determination value T/2” is obtained by 2/2, standing at 0. The column determination value Ta stands at 0, and the calculating unit 21 therefore determines that the column corresponding to the calculation target slave apparatus is an odd-numbered column.

Thus, the processing proceeds to Step S223C. Under the prerequisite F5, the vertically adjacent direction is the +V direction, and thus, the processing in Step S223C is followed by the processing in Step S224E. The remainder MC of the expression “CT/Vm” is obtained by 6/3, standing at 0. The expression obtained by substitution of the value (MC=0) under the prerequisite F5 into the expression (5) in the calculation processing V3, or equivalently, “0+1=1” provides 1 as the coordinate VL.

Under the prerequisite F5, the horizontally adjacent direction is the +H direction, and the processing in Step S226C is therefore performed. MD that is the integer part of the value given by the expression “CT/Vm” is obtained by 6/3=2, standing at 2. The expression obtained by substitution of the value (MD=2) under the prerequisite F5 into the expression (7) in the calculation processing H5, or equivalently, “2+1=3” provides 3 as the coordinate HL. Thus, the calculations provide the coordinates P (3, 1) as the coordinates of the video display apparatus 100-7 being the salve apparatus under the prerequisite F5.

Next, the following describes the procedures for calculation of the identification number i under the prerequisite F5. Under the prerequisite F5, the identification setting rule is the horizontal setting rule, and thus, the processing is performed in the stated order of Steps S231 and S232A in FIG. 14. In the calculation processing B1 in Step S232A, the calculating unit 21 provides 3 as the identification number i through the expression obtained by substitution of the values (HL=3, VL=1, and Hm=4) under the prerequisite F5 into the expression (9), or equivalently, “3+(1−1)×4=3.”

As described above, the calculations provide the coordinates P (1, 1) as the coordinates of the master apparatus under the prerequisite D1. Under the prerequisite D1, the master apparatus is located in the upper-left end LT. Under the prerequisite D1, the cable connection configuration is the vertical connection configuration. As described above, the calculations provide 1 as the identification number i of the master apparatus under the prerequisite E1.

Assume that the coordinates P and the identification number i are calculated on the condition that the calculation target apparatus under the prerequisite F4 is any one of the video display apparatuses 100-2, 100-3, 100-4, 100-5, 100-6, 100-8, 100-9, 100-11, and 100-12. Then, assume that the coordinates P and the identification numbers i of the individual video display apparatuses 100 calculated as described above, the coordinates P and the identification number i of the video display apparatus 100-10 obtained under the above-mentioned prerequisite F4, the coordinates P and the identification number i of the video display apparatuses 100-7 obtained under the above-mentioned prerequisite F5, and the coordinates P and the identification number i of the video display apparatus 100-1 are set to the corresponding ones of the video display apparatuses 100 through the processing in FIG. 11 and FIG. 15.

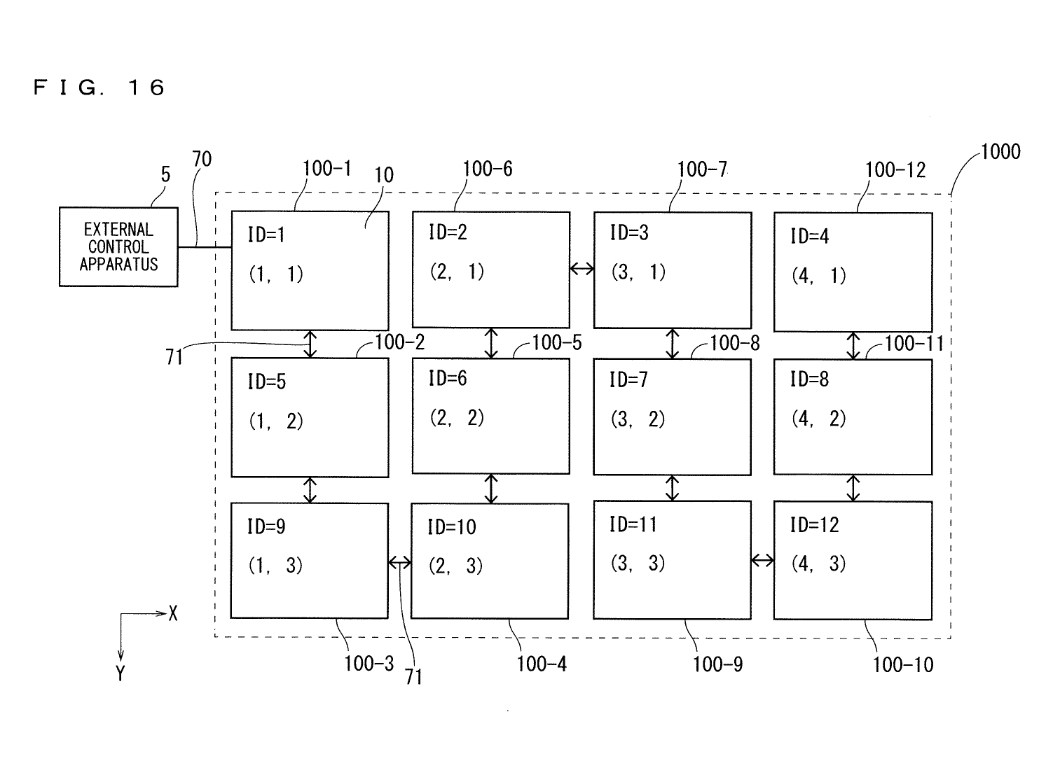

In this case, the identification numbers i and the coordinates P of the individual video display apparatuses 100 are as shown in FIG. 16. FIG. 16 illustrates the state in which the identification number i and the coordinates P set to the individual video display apparatus 100 are displayed on the screen 10 of the individual video display apparatus 100 concerned.

As described above, in this preferred embodiment, the calculating unit 21 of the master apparatus (the reference video display apparatus) that comes first in the transmission sequence calculates the coordinates P of the plurality of video display apparatuses 100 on the multiscreen 10A on the basis of the arrangement information KJ and the above-mentioned transmission sequence. The calculating unit 21 calculates the identification number i on the basis of the identification setting rule B. The setting unit 22 performs the processing for setting the identification number i of each of the video display apparatuses 100 with the calculated coordinates P to the video display apparatus 100 concerned.

For example, this eliminates the need for the conventional imaging apparatus and the like for calculating the coordinates P of the video display apparatuses 100. Thus, the coordinates P of the video display apparatuses 100 can be calculated through the simple configuration. This facilitates the calculation of the coordinates P and the identification numbers i of the individual video display apparatuses 100. As described above, the setting unit 22 performs the processing for setting the identification number i of each of the video display apparatuses 100 with the calculated coordinates P to the video display apparatus 100 concerned. Thus, the identification numbers i can be set to the video display apparatuses 100 through the simple configuration.

This preferred embodiment facilitates the calculation of the coordinates P and the identification numbers i of the individual video display apparatuses 100 without using a special apparatus such as the conventional imaging apparatus. This also facilitates the setting of the calculated coordinates P and the calculated identification numbers i.

In this preferred embodiment, the master apparatus is located in any one of four corners of the multiscreen 10A. The calculating unit 21 of the master apparatus calculates the coordinates P on the basis of the position of the master apparatus. To be a little more specific, the master apparatus can easily calculate the coordinates P on the basis of the cable connection configuration, the transmission sequence, the horizontal number Hm, and the vertical number Vm. That is, the master apparatus located in any one of four corners of the multiscreen 10A can easily calculate the coordinates P.

This preferred embodiment enables the setting of the identification numbers i to the individual video display apparatuses in the sequence according to the horizontal raster scanning or the vertical raster scanning. That is, each of the video display apparatuses 100 arranged in matrix and daisy-chain connected can easily set the identification number i to the video display apparatus 100 concerned on the basis of the identification setting rule defined to make it easier for the operator (a person) to recognize the identification number i without using the transmission sequence that follows the daisy chain connection.

In this preferred embodiment, the coordinates P and the identification numbers i calculated by the calculating unit 21 of the master apparatus are set to the individual slave apparatuses. This eliminates the need for the operator to set the coordinates P and the identification numbers i manually to the individual video display apparatuses.

In this preferred embodiment, the master apparatus can automatically calculate the coordinates P and the identification numbers i and can also automatically set the calculated coordinates P and the calculated identification numbers i to the individual video display apparatuses 100 that are daisy-chain connected.

In the initial installment of the conventional multiscreen display apparatus, all of the video display apparatuses included in the multiscreen display apparatus have the factory-configured coordinates and the factory-configured identification numbers, in other words, the same coordinates and the same identification number. In this case, the video display apparatuses have the same identification number, making it impossible to set, for example, the coordinates through the external device such as a PC. Thus, the operator needs to set the coordinates and the identification number to each of the video display apparatuses.

In this preferred embodiment, meanwhile, the operator sets defaults only to the master apparatus through the external control apparatus 5, whereby the coordinates and the identification numbers i are automatically set to the individual video display apparatuses 100 included in the multiscreen display apparatus 1000. This can significantly reduce the adjustment time required in the installment of the multiscreen display apparatus 1000.

In the conventional configuration, the identification number is set to each of the video display apparatuses in the above-mentioned transmission sequence based on the daisy chain connection. Consequently, the identification numbers do not follow the sequence according to the horizontal raster scanning or the vertical raster scanning.

In this preferred embodiment, meanwhile, the identification number i is automatically set to each of the video display apparatuses 100 in the sequence according to the horizontal raster scanning or the vertical raster scanning. This provides an easy-to-understand correspondence between the identification numbers i and the coordinates P of the video display apparatus 100 in the control of the multiscreen display apparatus 1000. This also prevents, for example, the occurrence of control errors in the adjustment and operation of the multiscreen display apparatus 1000.

In this preferred embodiment, the master apparatus located in any one of four corners of the multiscreen 10A can uniquely set the coordinates P and the identification numbers i of the video display apparatuses 100. Thus, in the multiscreen display apparatus 1000, the video display apparatus 100 in the upper-left end is not necessarily set as the master apparatus. That is, the video display apparatus 100 located closest to the external control apparatus 5 can be set as the master apparatus.

For the conventional setting of identification numbers in the configuration in which the individual video display apparatuses are daisy-chain connected through serial cables, the identification numbers are set according to the transmission sequence based on the daisy chain connection. The related art B requires an imaging apparatus such as a camera for detecting the positions of the individual video display apparatuses in the multiscreen display apparatus including the individual video display apparatuses arranged in matrix. This unfortunately increases the cost.

This preferred embodiment with the above-described configuration can solve the above-mentioned problems.

### Second Preferred Embodiment

In this preferred embodiment, the processing for setting the identification address is mainly described.

The identification address is, for example, an Internet Protocol (IP) address. In this preferred embodiment, the identification address is expressed in accordance with, for example, the Internet Protocol version 4 (IPv4). In this case, the identification address is expressed in 4 bytes (for example, 8 bits×4=32 bits). The identification address is expressed by a sequence of four numbers connected by a dot. Each of the numbers expressing the identification address is expressed in, for example, 8 bits. In this case, each of the numbers expressing the identification number is any number from 0 to 255. The identification address is expressed by, for example, “192. 168. 100. 32.”

The identification address is not limited to the IP address. The identification address may be, besides the IP address, the information for identifying the video display apparatuses 100 in the network NW. For example, the identification address may be expressed by numbers and/or characters.

The last number of the sequence of four numbers included in the identification address is hereinafter also referred to as “final address fAD” or “fAD.” The address including the sequence of three numbers out of the sequence of four numbers included in the identification address except for the final address fAD is hereinafter referred to as “partial address pAD” or “pAD.”

As an example, assume that the identification number is “192. 168. 100. 32.” In this case, the partial address pAD is “192. 168. 100” and the final address fAD is 32.

According to the factory configuration of the multiscreen display apparatus 1000, the identification addresses of the individual video display apparatuses 100 are fixed values. Thus, in the installment of the multiscreen display apparatus 1000, the identification addresses need to be set to the individual video display apparatuses 100 included in the multiscreen display apparatus 1000, avoiding overlap among the identification addresses of the individual video display apparatuses 100.

In this preferred embodiment, the individual video display apparatuses 100 included in the multiscreen display apparatus 1000 undergo the processing (hereinafter also referred to as “identification information setting correspondence processing”) for setting the identification address, being the identification information, and the coordinates P. The processing performed by the external control apparatus 5 in the identification information setting correspondence processing is hereinafter also referred to as “identification information setting correspondence processing NX.”

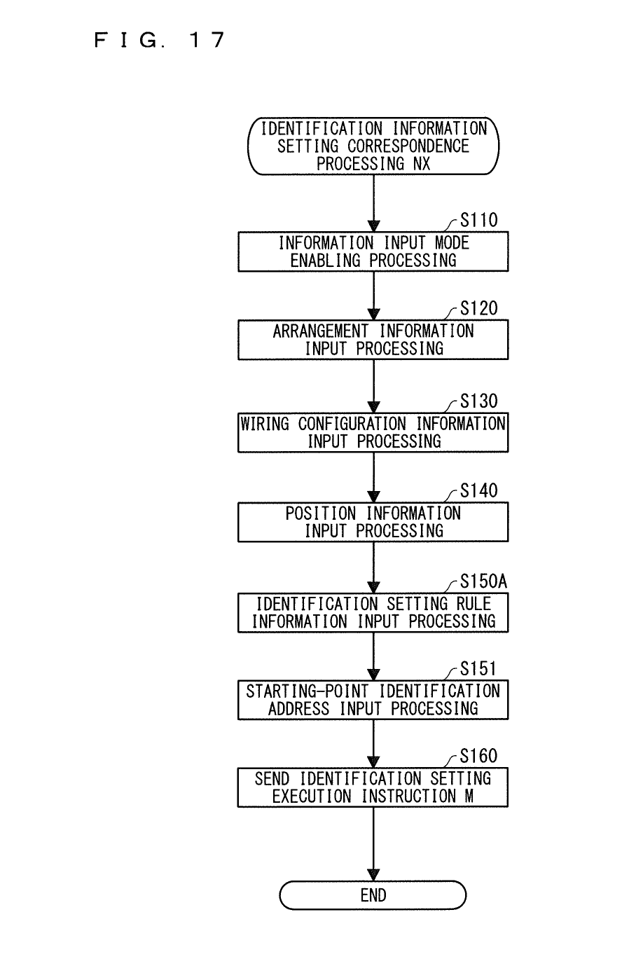

FIG. 17 is a flowchart of the identification information setting correspondence processing NX. With reference to FIG. 17, the processing in the steps denoted by the same numbers as the steps in FIG. 6 is performed as described in the first preferred embodiment, and the detailed description thereof is not repeated. The following mainly describes the aspects different form the first preferred embodiment.

As in the first preferred embodiment, the processing in Steps S110 and S120 is performed in the identification information setting correspondence processing NX. Thus, the control unit 20 causes the storing unit 32 to store the arrangement information KJ (the horizontal number Hm and the vertical number Vm).

In Step S130, as in the first preferred embodiment, the above-described wiring configuration information input processing for inputting the wiring configuration information W is performed. Thus, the control unit 20 causes the storing unit 32 to store the wiring configuration information W.

In this preferred embodiment, the reference video display apparatus (the master apparatus) is located in any one of four corners of the multiscreen 10A as described above. The four corners include the upper-left end LT, the upper-right end RT, the lower-left end LB, and the lower-right end RB in FIG. 7.

In Step S140, as in the first preferred embodiment, the position information input processing for inputting position information LT is performed. Thus, the control unit 20 of the master apparatus causes the storing unit 32 to store the position information LJ.

The rule for setting the identification addresses being the identification information to the individual video display apparatuses 100 is hereinafter also referred to as “identification setting rule N” or “identification setting rule.” The identification setting rule N is the predetermined rule for setting the identification address being the identification information to each of the video display apparatuses 100 included in the multiscreen display apparatus 1000. The identification setting rule N is defined to make it easier for the operator (a person) to recognize the identification address.

In Step S150A, the identification setting rule information input processing for inputting the identification setting rule information R is performed. The identification setting rule information R is the information for specifying the identification setting rule N.

The video display apparatus 100 to which the identification address is to be set is also referred to as “setting target video display apparatus.”

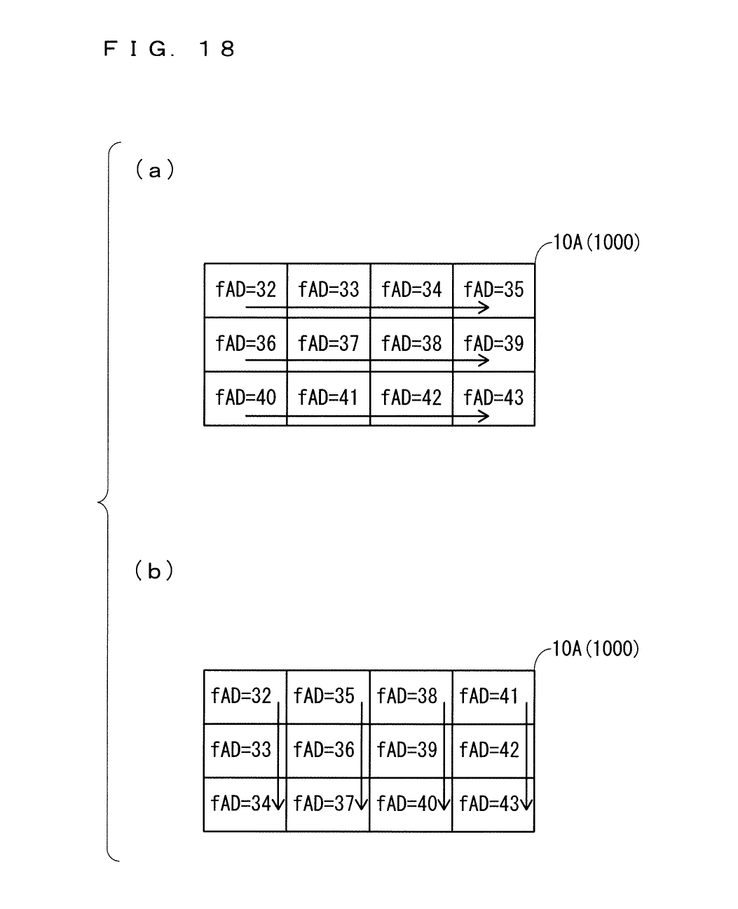

The identification setting rule for setting the identification address, as shown in part (a) in FIG. 18, to the individual video display apparatuses 100 included in the multiscreen display apparatus 1000 is hereinafter also referred to as “horizontal setting rule.” The identification addresses set to the individual video display apparatuses 100 differ from one another only in the final addresses fAD of the relevant identification addresses. To simply the drawing, part (a) in FIG. 18 indicates only the final addresses fAD of the identification addresses. As described above, the position of the master apparatus (the reference video display apparatus) on the multiscreen 10A is also referred to as “reference position BL.”

As an example, assume that the reference position BL is the upper-left end LT. In this case, the horizontal setting rule mentioned above is defined on the basis of the sequence according to the horizontal raster scanning. That is, according to the horizontal setting rule, the value of the final address fAD of the identification address to be set is incremented by 1 every time the setting target video display apparatus shifts form one of the video display apparatuses 100 corresponding to each row of the matrix MX to another video display apparatus 100 sitting to the immediate right.

In particular, according to the horizontal setting rule, the value of the final address fAD set to the video display apparatus 100 in the (HL+1)th column among the video display apparatuses 100 corresponding to each row of the matrix MX is greater by 1 than the value of the final address fAD set to the video display apparatus 100 in the HL-th column. For example, as shown in part (a) in FIG. 18, the value of the final address fAD set to the video display apparatus 100-2 in the second column among the video display apparatuses 100 corresponding to the first row of the matrix MX in FIG. 1 is 33, which is greater by 1 than the final address fAD (32) set to the video display apparatus 100-1 in the first column.

According to the horizontal setting rule, the setting target video display apparatus to which the identification address is to be set subsequent to the rightmost video display apparatus is the leftmost video display apparatus corresponding to the row next to the row of the matrix MX corresponding to the relevant rightmost video display apparatus. For example, according to the horizontal setting rule, the setting target video display apparatus to which the identification address is to be set subsequent to the video display apparatus 100-4 corresponding to the first row of the matrix MX is the video display apparatus 100-8 corresponding to the second row of the matrix MX.

The identification setting rule for setting the identification address, as shown in part (b) in FIG. 18, to the individual video display apparatuses 100 included in the multiscreen display apparatus 1000 is hereinafter also referred to as “vertical setting rule.” To simplify the drawing, part (b) in FIG. 18 indicates only the final addresses fAD of the identification addresses.

As an example, assume that the reference position BL is the upper-left end LT. In this case, the vertical setting rule is defined on the basis of the sequence according to the vertical raster scanning. That is, according to the vertical setting rule, the value of the final address fAD to be set is incremented by 1 every time the setting target video display apparatus shifts from one of the video display apparatuses 100 corresponding to each column of the matrix MX to another video display apparatus 100 sitting immediately below.

In particular, according to the vertical setting rule, the value of the final address fAD set to the video display apparatus 100 in the (VL+1)th row among the video display apparatuses 100 corresponding to each column of the matrix MX is greater by 1 than the value of the final address fAD set to the video display apparatus 100 in the VL-th row. For example, with reference to FIG. 9, the value of the final address fAD set to the video display apparatus 100-2 in the second row among the video display apparatuses 100 corresponding to the first column of the matrix MX is 33, which is greater by 1 than the final address fAD (32) set to the video display apparatus 100-1 in the first row.

According to the vertical setting rule, the setting target video display apparatus to which the identification address is to be set subsequent to the bottom video display apparatus is the top video display apparatus corresponding to the column next to the column of the matrix MX corresponding to the relevant bottom video display apparatus. For example, according to the vertical setting rule, the setting target video display apparatus to which the identification address is to be set subsequent to the video display apparatus 100-3 corresponding to the first column of the matrix MX is the video display apparatus 100-6 corresponding to the second column of the matrix MX.

Referring back to FIG. 17, in the identification setting rule information input processing in Step S150A, the processing is performed as in Step S150, and the detailed description thereof is not repeated. The following provides a brief description. In the identification setting rule information input processing, the operator inputs the identification setting rule information R to the external control apparatus 5, using the operation interface. The processing is performed as in Step S150, so that the control unit 20 of the master apparatus causes the storing unit 32 to store the identification setting rule information R.

The identification address to be set to the master apparatus (the reference video display apparatus) is hereinafter also referred to as “starting-point identification address.” The final address fAD of the starting-point identification address is hereinafter also referred to as “starting-point final address fADa” or “fADa.” The address including the sequence of three numbers out of the sequence of four numbers included in the starting-point identification address except for the starting-point final address fADa is hereinafter referred to as “starting-point partial address pADa” or “pADa.”

In Step S151, a starting-point identification address input processing is performed. In the starting-point identification address input processing, the operator inputs the starting-point identification address to the external control apparatus 5, using the operation interface. As an example, assume that the starting-point identification address is “192. 168. 100. 32.” In this case, the starting-point partial address pADa is “192. 168. 100” and the starting-point final address fADa is 32.

Then, the external control apparatus 5 sends, to the master apparatus, the starting-point identification address that has been input. Only the master apparatus is set as the delivery target of the starting-point identification address. Thus, the communication processing unit 33 of the master apparatus receives the starting-point identification address from the external control terminal 34. Then, the communication processing unit 33 sends the starting-point identification address only to the control unit 20. The control unit 20 causes the storing unit 32 to store the starting-point identification address. Thus, the storing unit 32 stores the starting-point partial address pADa and the starting-point final address fADa included in the starting-point identification address.

In Step S160, the external control apparatus 5 sends the identification setting execution instruction M to the master apparatus (the video display apparatus 100-1). The identification setting execution instruction M is the instruction for causing the master apparatus to execute the processing (hereinafter also referred to as “identification information setting correspondence processing NM”) for setting the identification address being the identification information. Only the master apparatus is the delivery target of the identification setting execution instruction M. That is, the identification setting execution instruction M is sent only to the master apparatus.

The master apparatus executes the identification information setting correspondence processing NM upon receipt of the identification setting execution instruction M. In particular, the communication processing unit 33 of the master apparatus receives the identification setting execution instruction M from the external control terminal 34. Then, the communication processing unit 33 sends the identification setting execution instruction M only to the control unit 20. Thus, the control unit 20 of the master apparatus receives the identification setting execution instruction M. The control unit 20 executes the identification information setting correspondence processing NM in accordance with the identification setting execution instruction M.

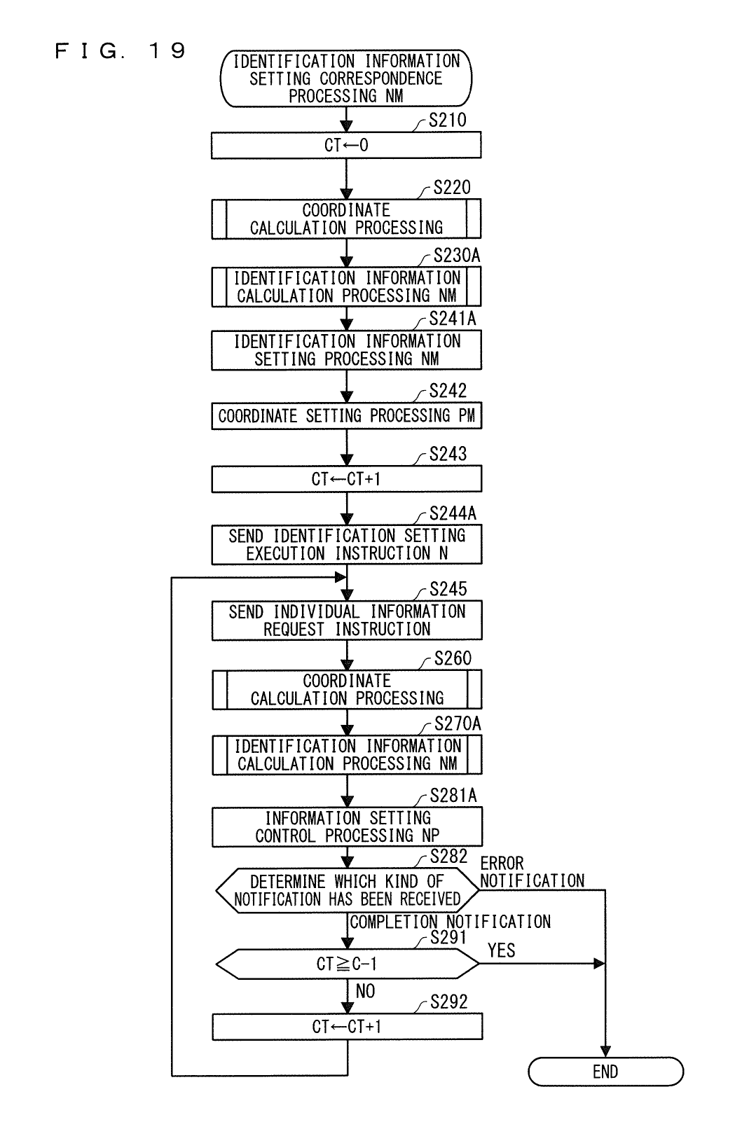

Next, the identification information setting correspondence processing NM is described. FIG. 19 is a flowchart of the identification information setting correspondence processing NM. With reference to FIG. 19, the processing in the steps denoted by the same numbers as the steps in FIG. 11 is performed as described in the first preferred embodiment, and the detailed description thereof is not repeated. The following mainly describes the aspects different form the first preferred embodiment. As in the first preferred embodiment, the processing in Steps S210 and S220 is performed in the identification information setting correspondence processing NM.

In Step S220, the coordinate calculation processing is performed as in the first preferred embodiment, and the detailed description thereof is not repeated. In the coordinate calculation processing, as described above, the calculating unit 21 calculates the coordinates P (positions) of the plurality of video display apparatuses 100 included in the multiscreen display apparatus 1000 on the multiscreen 10A on the basis of the arrangement information KJ and the transmission sequence described above. To be a little more specific, the calculating unit 21 calculates the coordinates P on the basis of the position of the master apparatus being the reference video display apparatus. After the coordinate calculation processing is ended, the processing returns to the identification information setting correspondence processing NM in FIG. 19, and the processing in Step S230A is performed.

In Step S230A, an identification information calculation processing NM is performed. To sum up, in the identification information calculation processing NM, the calculating unit 21 calculates the identification address being the identification information on the basis of the identification setting rule.

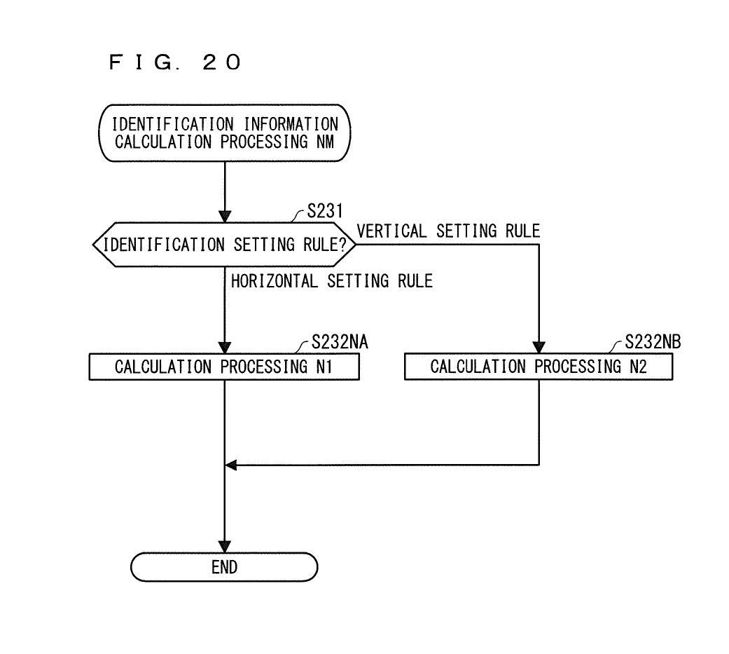

FIG. 20 is a flowchart of the identification information calculation processing NM. With reference to FIG. 20, the processing in the steps denoted by the same numbers as the steps in FIG. 14 is performed as described in the first preferred embodiment, and the detailed description thereof is not repeated. The following mainly describes the aspects different form the first preferred embodiment. The video display apparatus 100 whose identification address being the identification information is to be calculated in the identification information calculation processing NM is hereinafter also referred to as “target apparatus ND.” Firstly, the processing in Step S231 is performed in the identification information calculation processing NM.

In Step S231, the processing is performed as in the first preferred embodiment. Thus, if the identification setting rule is the horizontal setting rule, or equivalently, if the identification setting rule information R is the information specifying the horizontal setting rule, the processing proceeds to Step S232NA. Meanwhile, if the identification setting rule is the vertical setting rule, or equivalently, if the identification setting rule information R is the information specifying the vertical setting rule, the processing proceeds to Step S232NB.

In Step S232NA, a calculation processing N1 for calculating the final address fAD and the identification address is performed. In the calculation processing N1, the calculating unit 21 calculates the final address fAD by the following expression (11), using the calculated coordinates P (HL, VL), the horizontal number Hm, and the vertical number Vm.

fAD=(fADa−1)+HL+(VL−1)×Hm Expression (11)

In expression (11), “fADa” refers to the “starting-point final address fADa” mentioned above.

Then, through calculations, the calculating unit 21 provides, as the identification address, the address including the starting-point partial address pADa stored in the storing unit 32 and the calculated final address fAD that are connected to each other by a dot (•).

In Step S232NB, a calculation processing N2 for calculating the final address fAD and the identification address is performed. In the calculation processing N2, the calculating unit 21 calculates the final address fAD by the following expression (12) using the calculated coordinates P (HL, VL).

fAD=(fADa−1)+(HL−1)×Vm+VL Expression (12)

Then, through calculations, the calculating unit 21 provides, as the identification address, the address including the starting-point partial address pADa stored in the storing unit 32 and the calculated final address fAD that are connected to each other by a dot (•).

The above-mentioned calculations provide the final address fAD and the identification address. In some cases (hereinafter also referred to as “situation A”), the value of fAD calculated by the expression (11) or the expression (12) exceeds 255.

In the situation A, the calculating unit 21 performs, in the calculation processing N1 or the calculation processing N2, the processing for setting the value of fAD at any number from 0 to 255. In particular, through calculations, the calculating unit 21 provides the remainder of the expression “fAD/255” as the definitive fAD.

As an example, assume that fAD calculated by the expression (11) stands at 257. In this case, through calculations, the calculating unit 21 provides 2, being the remainder of the expression “257/255,” as the definitive fAD in the calculation processing N1.

The following describes the procedures for calculation of the identification address of the master apparatus under the following prerequisite E1. Under the prerequisite E1, the twelve video display apparatuses 100 are arranged in a matrix, being the matrix MX, with three rows and four columns as shown in FIG. 2. Under the prerequisite E1, the horizontal number Hm stands at 4 and the vertical number Vm stands at 3. Under the prerequisite E1, the master apparatus is located in the upper-left end LT. Under the prerequisite E1, the master apparatus has the coordinates (1, 1). Under the prerequisite E1, the identification setting rule is the horizontal setting rule. Under the prerequisite E1, the starting-point address is “192. 168. 100. 32.” That is, under the prerequisite E1, the starting-point partial address pADa is “192. 168. 100” and the starting-point final address fADa is 32.

Under the above-mentioned prerequisite E1, the processing is performed in the stated order of Steps S231 and S232NA. In the calculation processing N1 in Step S232NA, the calculating unit 21 provides 32 as the final address fAD through the expression obtained by substitution of the values (fADa=32, HL=1, VL=1, and Hm=4) under the prerequisite E1 into the expression (11), or equivalently, “(32−1)+1+(1−1)×4=32.”

Then, through calculations, the calculating unit 21 provides the identification address “192. 168. 100. 32” being the address including the starting-point partial address pADa “192. 168. 100” and the calculated final address fAD (32) that are connected to each other by a dot (•).

As another example, the following describes the procedures for calculation of the final address fAD of the master apparatus under the prerequisite E2. The prerequisite E2 differs from the prerequisite E1 only in that the identification setting rule is the vertical setting rule. The prerequisite E2 except for the above aspect is the same as the prerequisite E1.

Under the prerequisite E2, the processing is performed in the stated order of Steps S231 and S232NB. In the calculation processing N2 in Step S232NB, the calculating unit 21 provides 32 as the final address fAD through the expression obtained by substitution of the values (fADa=32, HL=1, Vm=3, and VL=1) under the prerequisite E2 into the expression (12), or equivalently, (32−1)+(1−1)×3+1=32.

Then, through calculations, the calculating unit 21 provides the identification address “192. 168. 100. 32” being the address including the starting-point partial address pADa “192. 168. 100” and the calculated final address fAD (32) that are connected to each other by a dot (•).

As described above, in the identification information calculation processing NM, the calculating unit 21 calculates the final address fAD and the identification address being the identification information on the basis of the identification setting rule, using the expression (11) or the expression (12). After the identification information calculation processing NM is ended, the processing returns to the identification information setting correspondence processing NM in FIG. 19 and the processing in Step S241A is performed.

In Step S241A, an identification information setting processing NM is performed. In the identification information setting processing NM, the setting unit 22 of the control unit 20 performs the processing for setting the identification address of the video display apparatus (the master apparatus) with the calculated coordinates P to the video display apparatus (the master apparatus) concerned. In particular, the setting unit 22 causes the storing unit 32 to store the identification address calculated in the identification information calculation processing NM. Consequently, the identification address is set to the master apparatus.

In Step S242, the processing is performed as in the first preferred embodiment. Thus, the setting unit 22 performs the processing for setting the coordinates P of the video display apparatus (the master apparatus) with the calculated coordinates P to the video display apparatus (the master apparatus) concerned.

In Step S243, the calculating unit 21 (the control unit 20) increments the value of the counter CT by 1. Thus, the value of the counter CT stands at 1.

In Step S244A, the control unit 20 sends an identification setting execution instruction N to all of the salve apparatuses. The identification setting execution instruction N is the instruction for causing the slave apparatus to set the identification address being the identification information. In other words, the identification setting execution instruction N is the instruction for causing the slave apparatus to execute the processing (hereinafter also referred to as “identification information setting correspondence processing NS”) for setting the identification address. The identification setting execution instruction N is also the instruction for shifting the operation mode of the slave apparatus to the identification setting mode.

In particular, the control unit 20 of the master apparatus sends the identification setting execution instruction N, with the set delivery targets being all of the slave apparatuses, to the slave apparatus (the video display apparatus 100-2) that comes second in the transmission sequence. The identification setting execution instruction N indicates the starting-point partial address pADa and the temporally assigned final address fAD. As an example, assume that the number 256 is set as the value of the temporarily assigned final address fAD. Thus, the identification setting execution instruction N is sent to all of the slave apparatuses through the communication channel SK according to the above-mentioned transmission sequence.

Consequently, in each of the slave apparatuses, the control unit 20 receives the identification setting execution instruction N. In particular, the communication processing unit 33 receives the identification setting execution instruction N form the previous adjacent video display apparatus 100 (the master apparatus or the slave apparatus) through the input terminal 35a. The communication processing unit 33 sends the received identification setting execution instruction N to the control unit 20 and the output terminal 35b. The control unit 20 thus receives the identification setting execution instruction N.

The value of the temporarily assigned final address fAD indicated by the identification setting execution instruction N is not limited to 256 and may be any number other than the numbers (0 to 255) that can be actually set as the final address fAD.

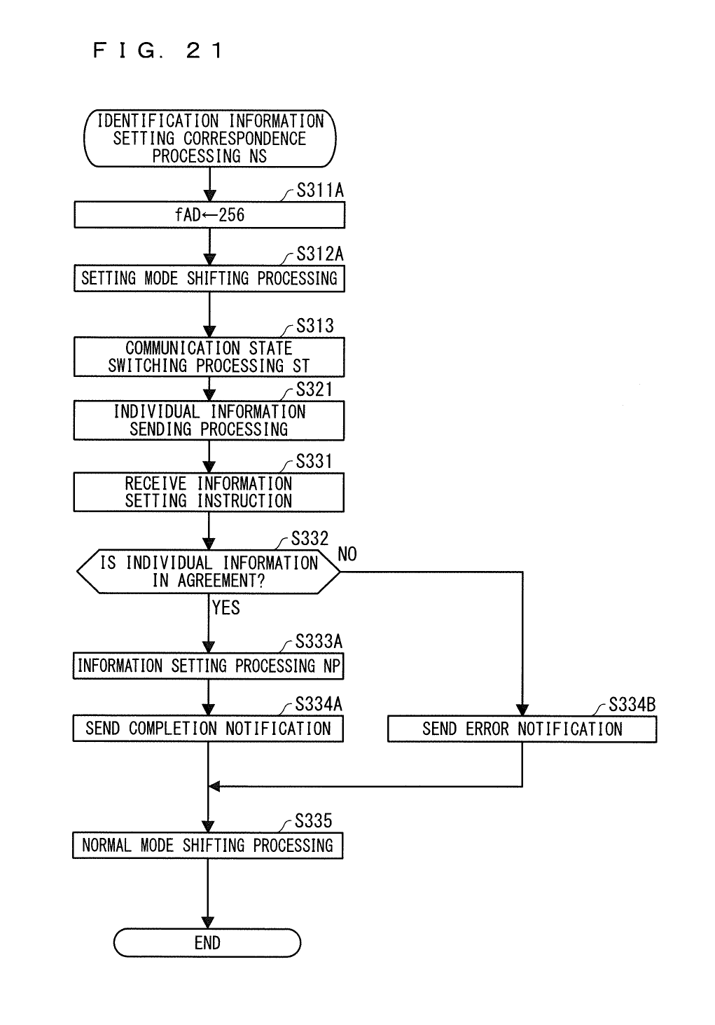

The control unit 20 of the individual salve apparatus executes the identification information setting correspondence processing NS upon receipt of the identification setting execution instruction N. FIG. 21 is a flowchart of the identification information setting correspondence processing NS. With reference to FIG. 21, the processing in the steps denoted by the same numbers as the steps in FIG. 15 is performed as described in the first preferred embodiment, and the detailed description thereof is not repeated. The following mainly describes the aspects different form the first preferred embodiment. Firstly, the processing in Step S311A is performed in the identification information setting correspondence processing NS.

In Step S311A, the identification address fAD is set to 256. In particular, the control unit 20 causes the storing unit 32 to store the temporarily assigned final address fAD (256) indicated by the received identification setting execution instruction N. To be more specific, the control unit 20 causes the storing unit 32 to store the temporarily assigned identification address including the starting-point partial address pADa indicated by the identification setting execution instruction N and the temporarily assigned final address fAD indicated by the identification setting execution instruction N that are connected to each other by a dot (•). That is, the final address fAD of the temporarily assigned identification address stored in the storing unit 32 is 256.

As an example, assume that the starting-point partial address pADa is “192. 168. 100” and the temporarily assigned final address fAD is 256. In this case, the temporarily assigned identification address stored in the storing unit 32 is “192. 168. 100. 256.”

In Step S312A, the setting mode shifting processing is performed. In the setting mode shifting processing, the control unit 20 shifts the operation mode of the salve apparatus from the above-mentioned normal mode to the identification setting mode in accordance with the identification setting execution instruction N.

In Step S313, the processing is performed as in the first preferred embodiment.

In the master apparatus, the processing in Step S244A is followed by the Step S245. The slave apparatus whose final address fAD of the identification address is set to 256 is hereinafter also referred to as “target slave apparatus.”

In Step S245, the processing is performed as in the first preferred embodiment.

Thus, the individual information request instruction is sent to all of the target slave apparatuses according to the above-mentioned transmission sequence.

Upon receipt of the individual information request instruction, the target slave apparatus performs the processing in Step S321.

In Step S321, the individual information sending processing is performed as in the first preferred embodiment.

As described above, the slave apparatus corresponding to the individual information received by the master apparatus is hereinafter also referred to as “response slave apparatus.” In a case where the individual information sending processing is performed for the first time, the response slave apparatus refers only to the video display apparatus 100-2.

Upon receipt of the individual information, the master apparatus performs the processing in Step S260. In Step S260, the coordinate calculation processing in FIG. 12 is performed. The coordinates P of the response salve apparatus are calculated through the coordinate calculation processing. The example of the calculation of the coordinates P of the response slave apparatus will be described later.

In Step S270A, the identification information calculation processing NM in FIG. 20 is performed. The identification address of the response salve apparatus is calculated through the identification information calculation processing NM. The example of the calculation of the identification address of the response slave apparatus will be described later.

In Step S281A, an information setting control processing NP is performed. The information setting control processing NP is the processing for setting, through the setting unit 22, the identification address to the video display apparatus (the response slave apparatus) with the calculated coordinates P to the video display apparatus concerned. The information setting control processing NP is also the processing for setting, through the setting unit 22, the coordinates P of the video display apparatus (the response slave apparatus) with the calculated coordinates P to the video display apparatus (the response slave apparatus) concerned.

In particular, in the information setting control processing NP, the setting unit 22 sends the information setting instruction to the response salve apparatus. The information setting instruction is the instruction for setting the calculated identification address and the calculated coordinates P of the response slave apparatus to the response slave apparatus. The information setting instruction indicates the identification address and the coordinates P of the response salve apparatus. The information setting instruction also indicates the individual information of the response slave apparatus received by the master apparatus.

In the response slave apparatus, the control unit 20 receives the information setting instruction in Step S331.

In Step S332, the processing is performed as in the first preferred embodiment. If Step S332 results in YES, the processing proceeds to Step S333A. If Step S332 results in NO, the processing proceeds to Step S334B.

In Step S333A, an information setting processing NP is performed. In the information setting processing NP, the setting unit 22 sets the identification address indicated by the received information setting instruction to the own apparatus (the response slave apparatus). In particular, the setting unit 22 changes the temporarily assigned identification address stored in the storing unit 32 to identification address indicated by the information setting instruction.

The setting unit 22 sets the coordinates P indicated by the received information setting instruction to the own apparatus (the response salve apparatus). In particular, the setting unit 22 causes the storing unit 32 to store the coordinates P indicated by the information setting instruction.

In Step S334A, the control unit 20 (the setting unit 22) sends a completion notification to the master apparatus. The completion notification is the notification that the setting of the identification address and the coordinates has been completed.

In Step S335, the normal mode shifting processing is performed as in the first preferred embodiment. Then, the identification information setting correspondence processing NS is ended.

If Step S332 results in NO, the processing in Step S334B is performed as in the first preferred embodiment.

Upon receipt of the completion notification or the error notification through the above-described processing, the master apparatus performs the processing in Step S282.

In Step S282, the processing is performed as in the first preferred embodiment. If the control unit 20 receives the completion notification, the processing proceeds to Step S291. If the control unit 20 receives the error notification, the identification information setting correspondence processing NM is ended.

As described above, the number of the video display apparatuses 100 included in the multiscreen display apparatus 1000 is also referred to as “constituent number C” or “C.”

In Step S291, the processing is performed as in the first preferred embodiment.

If Step S291 results in YES, the identification information setting correspondence processing NM is ended. For YES in Step S291, the setting of the coordinates P and the identification address has been completed for all of the video display apparatuses 100 included in the multiscreen display apparatus 1000. For NO in Step S291, meanwhile, the processing proceeds to Step S292.

In Step S292, the calculating unit 21 increments the value of the counter CT by 1. Then, the processing in Step S245 is performed again.

In a case where the control unit 20 continuously fails to receive the error notification or the value of the counter CT continues to be less than “C−1” through the identification information setting correspondence processing NM described above, the processing in Steps S245 to S292 is repeatedly performed. Thus, Step S281A is repeatedly performed. Step S281A is repeatedly performed, so that the setting unit 22 performs the processing for setting the identification address of each of the video display apparatuses (the response slave apparatuses) with the calculated coordinates P to the video display apparatus (the response slave apparatuses) concerned. Step S281A is repeatedly performed, so that the setting unit 22 performs the processing for setting the coordinates P of each of the video display apparatuses (the response slave apparatuses) with the calculated coordinates P to the video display apparatus (the response salve apparatus) concerned.

Every time the processing in Steps S245 to S292 is performed, the number of the target slave apparatuses decreases.

Every time the processing in Steps S245 to S292 is performed, the processing A described below is performed. In the processing A, the individual information request instruction is sent to each of the target slave apparatuses through Step S245. In the processing A, upon receipt of the individual information request instruction, the target slave apparatuses perform the processing in Step S321.

For example, in a case where the second round of the processing in Step S245 is performed, the master apparatus receives the individual information of the video display apparatus 100-3 only from the video display apparatus 100-3. In this case, the response slave apparatus refers only to the video display apparatus 100-3. In this case, the value of the counter CT used to calculate the coordinates P and the identification address of the video display apparatus 100-3 stands at 2.

That is, through the identification information setting correspondence processing NM described above, the master apparatus increments the value of the counter CT, and along with the incrimination, sets the coordinates P and the identification address to each of the slave apparatuses according to the transmission sequence.

If “CT=C−1” is satisfied (YES in Step S291), the master apparatus determines that the setting of the identification address has been completed for the video display apparatuses including the terminal video display apparatus mentioned above, and the identification information setting correspondence processing NM is ended.

The following describes the procedures for calculation of the coordinates P and the identification addresses of the slave apparatuses. The salve apparatus whose coordinates P and identification address are to be calculated is hereinafter also referred to as “calculation target slave apparatus.” Firstly, the following describes the procedures for calculating the coordinates P and the identification address of the calculation target slave apparatus under the following prerequisite F1.

Under the prerequisite F1, the twelve video display apparatuses 100 are arranged in a matrix, being the matrix MX, with three rows and four columns as shown in FIG. 2. Under the prerequisite F1, the calculation target slave apparatus is the video display apparatus 100-6. Under the prerequisite F1, CT stands at 5. Under the prerequisite F1, the horizontal number Hm stands at 4 and the vertical number Vm stands at 3. Under the prerequisite F1, the master apparatus is located in the upper-left end LT. Thus, as shown in part (a) in FIG. 13, the horizontally adjacent direction is the +H direction and the vertically adjacent direction is the +V direction. Under the prerequisite F1, the cable connection configuration is the horizontal connection configuration. Under the prerequisite F1, the identification setting rule is the horizontal setting rule. Under the prerequisite F1, the stating-point final address fADa is 32. Under the prerequisite F1, the starting-point partial address pADa is “192. 168. 100.”

The procedures for calculation of the coordinates P under the above-mentioned prerequisite F1 are the same as the procedures in the first preferred embodiment, and the detailed description thereof is not repeated. Under the prerequisite F2, the calculations through the processing in FIG. 12 provide the coordinates P (2, 2) as the coordinates of the video display apparatus 100-6 being the slave apparatus.

Next, the following describes the procedures for calculation of the identification address under the prerequisite F1. Under the prerequisite F1, the identification setting rule is the horizontal setting rule, and thus, the processing is performed in the stated order of Steps S231 and S232NA in FIG. 20.

In the calculation processing N1 in Step S232NA, the calculating unit 21 provides 38 as the final address fAD through the expression obtained by substitution of the values (fADa=32, HL=3, VL=2, and Hm=4) under the prerequisite F1 into the expression (11), or equivalently, “(32−1)+3+(2−1)×4=38.”

Then, through calculations, the calculating unit 21 provides the identification address “192. 168. 100. 38” being the address including the starting-point partial address pADa “192. 168. 100” and the calculated final address fAD “38” that are connected to each other by a dot (•).

Next, as another example, the following describes the procedures for calculation of the coordinates P and the identification address of the calculation target slave apparatus under the prerequisite F2. The prerequisite F2 differs from the prerequisite F1 only in that the master apparatus is located in the upper-right end RT instead of being located in the upper-left end LT. The prerequisite F2 except for the above aspect is the same as the prerequisite F1. Under the prerequisite F2, the horizontally adjacent direction is the −H direction.

Next, the following describes the procedures for calculation of the identification address under the prerequisite F2. Under the prerequisite F2, the identification setting rule is the horizontal setting rule, and thus, the processing is performed in the stated order of Steps S231 and S232NA in FIG. 20. In the calculation processing N1 in Step S232NA, the calculating unit 21 provides 37 as the final address fAD through the expression obtained by substitution of the values (fADa=32, HL=2, VL=2, and Hm=4) under the prerequisite F2 into the expression (11), or equivalently, “(32−1)+2+(2−1)×4=37.”

Then, through calculations, the calculating unit 21 provides the identification address “192. 168. 100. 37” being the address including the starting-point partial address pADa “192. 168. 100” and the calculated final address fAD “37” that are connected to each other by a dot (•).

As another example, the following describes the procedures for calculation of the coordinates P and the identification address of the calculation target slave apparatus under the prerequisite F3. The prerequisite F3 differs from the prerequisite F1 only in that the calculation target slave apparatus is the video display apparatus 100-9. The prerequisite F3 except for the above aspect is the same as the prerequisite F1. Under the prerequisite F3, CT stands at 8.

The procedures for calculation of the coordinates P under the above-mentioned prerequisite F3 are similar to the procedures in the first preferred embodiment, and the detailed description thereof is not repeated. Under the prerequisite F3, the calculations through the processing in FIG. 12 provide the coordinates P (1, 3) as the coordinates of the video display apparatus 100-9 being the slave apparatus.

Next, the following describes the procedures for calculation of the identification address under the prerequisite F3. Under the prerequisite F3, the identification setting rule is the horizontal setting rule, and thus, the processing is performed in the stated order of Steps S231 and S232NA in FIG. 20. In the calculation processing N1 in Step S232NA, the calculating unit 21 provides 40 as the final address fAD through the expression obtained by substitution of the values (fAD=32, HL=1, VL=3, and Hm=4) under the prerequisite F3 into the expression (11), or equivalently, “(32−1)+1+(3−1)×4=40.”

Then, through calculations, the calculating unit 21 provides the identification address “192. 168. 100. 40” being the address including the starting-point partial address pADa “192. 168. 100” and the calculated final address fAD “40” that are connected to each other by a dot (•).

Next, as another example, the following describes the procedures for calculation of the coordinates P and the identification address of the calculation target slave apparatus under the prerequisite F4.

Under the prerequisite F4, the twelve video display apparatuses 100 are arranged in a matrix, being the matrix MX, with three rows and four columns as shown in FIG. 9. Under the prerequisite F4, the calculation target slave apparatus is the video display apparatus 100-10. Under the prerequisite F4, CT stands at 9. Under the prerequisite F4, the horizontal number Hm stands at 4 and the vertical number Vm stands at 3. Under the prerequisite F4, the master apparatus is located in the upper-left end LT. Thus, as shown in part (a) in FIG. 13, the horizontally adjacent direction is the +H direction and the vertically adjacent direction is the +V direction. Under the prerequisite F4, the cable connection configuration is the vertical connection configuration. Under the prerequisite F4, the identification setting rule is the horizontal setting rule. Under the prerequisite F4, the starting-point final address fADa is 32. Under the prerequisite F4, the starting-point partial address pADa is “192. 168. 100.”

The procedures for calculation of the coordinates P under the above-mentioned prerequisite F4 are similar to the procedures in the first preferred embodiment, and the detailed description thereof is not repeated. Under the prerequisite F4, the calculations through the processing in FIG. 12 provide the coordinates P (4, 3) as the coordinates of the video display apparatus 100-10 being the slave apparatus.

Next, the following describes the procedures for calculation of the identification address under the prerequisite F4. Under the prerequisite F4, the identification setting rule is the horizontal setting rule, and thus, the processing is performed in the stated order of Steps S231 and S232NA in FIG. 20. In the calculation processing N1 in Step S232NA, the calculating unit 21 provides 43 as the final address fAD through the expression obtained by substitution of the values (fADa=32, HL=4, VL=3, and Hm=4) under the prerequisite F4 into the expression (11), or equivalently, “(32−1)+4+(3−1)×4=43.”

Then, through calculations, the calculating unit 21 provides the identification address “192. 168. 100. 43” being the address including the starting-point partial address pADa “192. 168. 100” and the calculated final address fAD “43” that are connected to each other by a dot (•).

As another example, the following describes the procedures for calculation of the coordinates P and the identification address of the calculation target slave apparatus under the prerequisite F5. The prerequisite F5 differs from the prerequisite F4 only in that the calculation target slave apparatus is the video display apparatus 100-7. The prerequisite F5 except for the above aspect is the same as the prerequisite F4. Under the prerequisite F5, CT stands at 6.

The procedures for calculation of the coordinates P under the above-mentioned prerequisite 5 are similar to the procedures in the first preferred embodiment, and the detailed description thereof is not repeated. Under the prerequisite F5, the calculations through the processing in FIG. 12 provide the coordinates P (3, 1) as the coordinates of the video display apparatus 100-7 being the slave apparatus.

Next, the following describes the procedures for calculation of the identification address under the prerequisite F5. Under the prerequisite F5, the identification setting rule is the horizontal setting rule, and thus, the processing is performed in the stated order of Steps S231 and S232NA in FIG. 20. In the calculation processing N1 in Step S232NA, the calculating unit 21 provides 34 as the final address fAD through the expression obtained by substitution of the values (fADa=32, HL=3, VL=1, and Hm=4) under the prerequisite F5 into the expression (11), or equivalently, “(32−1)+3+(1−1)×4=34.”

Then, through calculations, the calculating unit 21 provides the identification address “192. 168. 100. 34” being the address including the starting-point partial address pADa “192. 168. 100” and the calculated final address fAD “34” that are connected to each other by a dot (•).

As described in the first preferred embodiment, the calculations provide the coordinates P (1, 1) as the coordinates of the master apparatus under the prerequisite D1. Under the prerequisite D1, the master apparatus is located in the upper-left end LT. Under the prerequisite D1, the cable connection configuration is the vertical connection configuration. As described above, the calculations provide “192. 168. 100. 32” as the identification address of the master apparatus under the prerequisite E1.

Assume that the coordinates P and the identification address are calculated on the condition that the calculation target apparatus under the prerequisite F4 is any one of the video display apparatuses 100-2, 100-3, 100-4, 100-5, 100-6, 100-8, 100-9, 100-11, and 100-12. Then, assume that the coordinates P and the identification addresses of the individual video display apparatuses 100 calculated as described above, the coordinates P and the identification address of the video display apparatus 100-10 obtained under the above-mentioned prerequisite F4, the coordinates P and the identification address of the video display apparatuses 100-7 obtained under the above-mentioned prerequisite F5, and the coordinates P and the identification address of the video display apparatus 100-1 are set to the corresponding ones of the video display apparatuses 100 through the processing in FIG. 19 and FIG. 21.

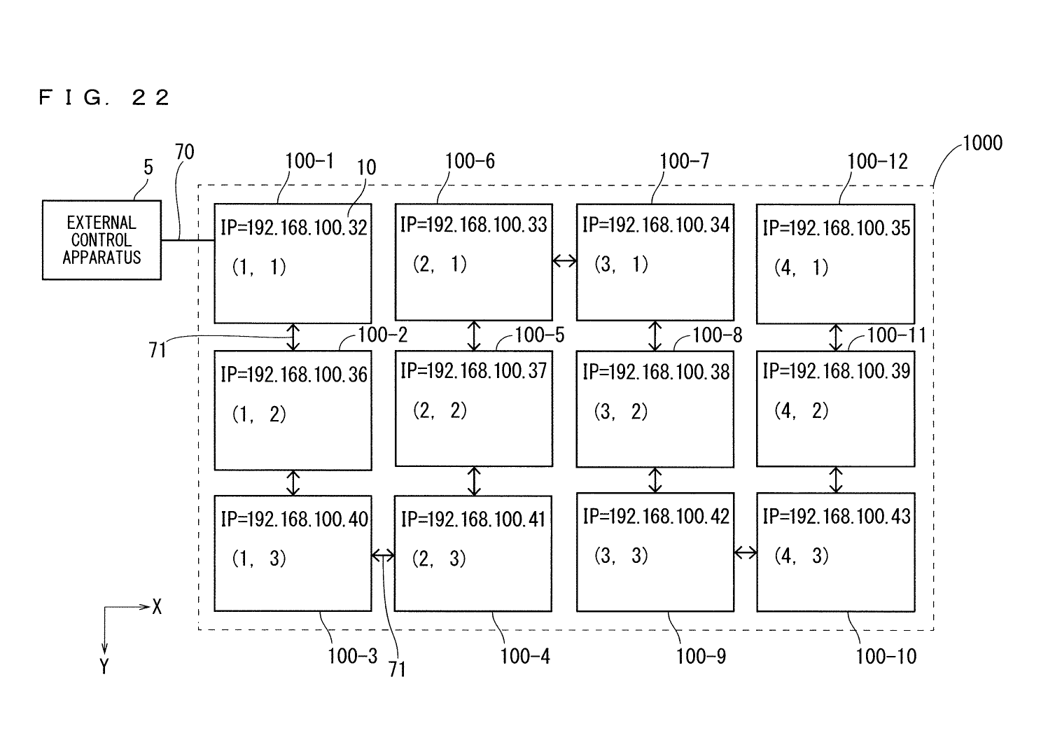

In this case, the identification addresses and the coordinates P of the individual video display apparatuses 100 are as shown in FIG. 22. FIG. 22 illustrates the state in which the identification address and the coordinates P set to the individual video display apparatus 100 are displayed on the screen 10 of the individual video display apparatus 100 concerned.

As described above, in this preferred embodiment, the calculating unit 21 of the master apparatus (the reference video display apparatus) that comes first in the transmission sequence calculates the coordinates P of the plurality of video display apparatuses 100 on the multiscreen 10A on the basis of the arrangement information KJ and the above-mentioned transmission sequence. The calculating unit 21 calculates the identification address on the basis of the identification setting rule N. The setting unit 22 performs the processing for setting the identification address of each of the video display apparatuses 100 with the calculated coordinates P to the video display apparatus 100 concerned.

For example, this eliminates the need for the conventional imaging apparatus and the like for calculating the coordinates P of the video display apparatuses 100. Thus, the coordinates P of the video display apparatuses 100 can be calculated through the simple configuration. This facilitates the calculation of the coordinates P and the identification addresses of the individual video display apparatuses 100. As described above, the setting unit 22 performs the processing for setting the identification address to each of the video display apparatuses 100 with the calculated coordinates P to the video display apparatus 100 concerned. Thus, the identification addresses can be set to the video display apparatuses 100 through the simple configuration.

This preferred embodiment facilitates the calculation of the coordinates P and the identification addresses of the individual video display apparatuses 100 without using a special apparatus such as the conventional imaging apparatus. This also facilitates the setting of the calculated coordinates P and the calculated identification addresses.

In this preferred embodiment, the master apparatus is located in any one of four corners of the multiscreen 10A as in the first preferred embodiment. The calculating unit 21 of the master apparatus calculates the coordinates P on the basis of the position of the master apparatus. Thus, the master apparatus located in any one of four corners of the multiscreen 10A can easily calculate the coordinates P.

This preferred embodiment enables the setting of the identification addresses to the individual video display apparatuses in the sequence according to the horizontal raster scanning or the vertical raster scanning. That is, each of the video display apparatuses 100 arranged in matrix and daisy-chain connected can easily set the identification address to the video display apparatus 100 concerned on the basis of the identification setting rule defined to make it easier for the operator (a person) to recognize the identification address without using the transmission sequence that follows the daisy chain connection.

In this preferred embodiment, the coordinates P and the identification addresses calculated by the calculating unit 21 of the master apparatus are set to the individual slave apparatuses. This eliminates the need for the operator to set the coordinates P and the identification addresses manually to the individual video display apparatuses.

In this preferred embodiment, the master apparatus can automatically calculate the coordinates P and the identification addresses and can also automatically set the calculated coordinates P and the calculated identification addresses to the individual video display apparatuses 100 that are daisy-chain connected.

In the initial installment of the conventional multiscreen display apparatus, all of the video display apparatuses included in the multiscreen display apparatus have the factory-configured coordinates and the factory-configured identification address, in other words, the same coordinates and the same identification address. In this case, the video display apparatuses have the same identification number, making it impossible to set, for example, the coordinates through the external device such as a PC. Thus, the operator needs to set the coordinates and the identification address to each of the video display apparatuses through, for example, the network.

In this preferred embodiment, meanwhile, the operator sets defaults only to the master apparatus through the external control apparatus 5, whereby the coordinates and the identification addresses are automatically set to the individual video display apparatuses 100 included in the multiscreen display apparatus 1000. This can significantly reduce the adjustment time required in the installment of the multiscreen display apparatus 1000.

In the conventional configuration, the identification address is set to each of the video display apparatuses in the above-mentioned transmission sequence based on the daisy chain connection. Consequently, the identification addresses do not follow the sequence according to the horizontal raster scanning or the vertical raster scanning.

In this preferred embodiment, meanwhile, the identification address is automatically set to each of the video display apparatuses 100 in the sequence according to the horizontal raster scanning or the vertical raster scanning. This provides an easy-to-understand correspondence between the identification address and the coordinates P of the video display apparatus 100 in the control of the multiscreen display apparatus 1000. This also prevents, for example, the occurrence of control errors in the adjustment and operation of the multiscreen display apparatus 1000.

In this preferred embodiment, the master apparatus located in any one of four corners of the multiscreen 10A can uniquely set the coordinates P and the identification address of the video display apparatus 100. Thus, in the multiscreen display apparatus 1000, the video display apparatus 100 in the upper-left end is not necessarily set as the master apparatus. That is, the video display apparatus 100 located closest to the external control apparatus 5 can be set as the master apparatus.

For the conventional setting of identification addresses in the configuration in which the individual video display apparatuses are daisy-chain connected through, for example, serial cables, the identification addresses are set according to the transmission sequence based on the daisy chain connection. The related art B requires an imaging apparatus such as a camera for detecting the positions of the individual video display apparatuses in the multiscreen display apparatus including the individual video display apparatuses arranged in matrix. This unfortunately increases the cost.

This preferred embodiment with the above-described configuration can solve the above-mentioned problems.

(Other Modifications)

The above description has been given on the multiscreen display apparatus (the video display apparatuses) according to the present invention on the basis of the preferred embodiments thereof. Meanwhile, the present invention is not limited to the above preferred embodiments. The present invention includes modification made to the above preferred embodiments by persons ordinarily skilled in the art without departing from the scope of the present invention. In the present invention, each preferred embodiment can be appropriately varied or omitted within the scope of the invention.

For example, the multiscreen display apparatus 1000 may executes, in succession, the processing in the first preferred embodiment and the processing in the second preferred embodiment. The processing in the first preferred embodiment refers to, for example, the processing in FIGS. 11, 12, 14, and 15. The processing in the second preferred embodiment refers to, for example, the processing in FIGS. 19, 12, 20, and 21.

The reference video display apparatus (the video display apparatus 100) included in the multiscreen display apparatus according to the present invention is hereinafter also referred to as “video display apparatus hz.”

For example, the video display apparatus hz does not necessarily include all of the constituent elements shown in FIG. 4. It is only required that the video display apparatus hz includes the minimum constituent components for the effects of the present invention. For example, if the control unit 20 is configured to perform the processing performed by the communication processing unit 33, the video display apparatus hz does not need to include the communication processing unit 33.

The functions of the calculating unit 21 and the setting unit 22 included in the video display apparatus hz may be implemented by processing circuitry. That is, the video display apparatus hz includes the processing circuitry to calculate the coordinates of the plurality of video display apparatuses on the multiscreen on the basis of the transmission sequence and the arrangement information for specifying the arrangement configuration of the plurality of video display apparatuses, to calculate the identification number for identifying each of the plurality of video display apparatuses on the basis of the predetermined rule for setting the identification number to each of the plurality of video display apparatuses, and to perform the processing for setting the identification number of each of the plurality of video display apparatuses with the calculated coordinates to the video display apparatus concerned.

The processing circuitry may be the dedicated hardware. The processing circuitry may be a processor that executes the program stored in the memory. The processor is, for example, a central processing unit (CPU), an arithmetic unit, a microprocessor, a microcomputer, or a digital signal processor (DSP).

The configuration in which the dedicated hardware serves as the processing circuitry is hereinafter also referred to as “configuration Cs1.” The configuration in which the processor serves as the processing circuitry is hereinafter also referred to as “configuration Cs2.” The configuration in which the functions of the calculating unit 21 and the setting unit 22 are implemented by the combination of hardware and software is hereinafter also referred to as “configuration Cs3.”

In the configuration Cs1, the processing circuitry refers to, for example, a single circuit, a composited circuit, a programmed processor, a parallel-programmed processor, an application specific integrated circuit (ASIC), a field programmable gate array (FPGA), or the combination of the above. The functions of the calculating unit 21 and the setting unit 22 may be implemented by the corresponding ones of two units of processing circuitry. All of the functions of the calculating unit 21 and the setting unit 22 may be implemented by one unit of processing circuitry.

As an example, the following describes the configuration in which the entirety or a part of the constituent components of the video display apparatus hz is indicated as the hardware. The video display apparatus representing the entirety or a part of the constituent components of the video display apparatus hz as the hardware is hereinafter referred to as “video display apparatus hd10.”

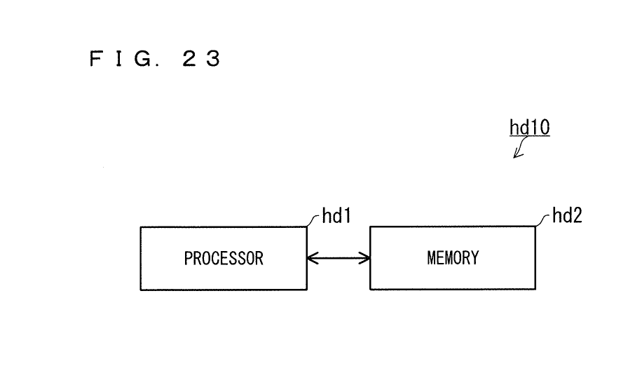

FIG. 23 is a configuration diagram of the hardware of the video display apparatus hd10. With reference to FIG. 23, the video display apparatus hd 10 includes a processor hd1 and a memory hd2. The memory hd2 is a volatile or nonvolatile semiconductor memory such as a random accessory memory (RAM), a read only memory (ROM), a flash memory, an erasable programmable read-only memory (EPROM), or an electrically erasable programmable read-only memory (EEPROM). The memory hd 2 is, for example, a magnetic disk, a flexible disk, an optical disk, a compact disk, a minidisk, or a DVD.

In the configuration Cs2, the processor hd1 serves as the processing circuitry. The processor hd1 is the control circuit 20 of the video display apparatus hz. In the configuration Cs2, the functions of the calculating unit 21 and the setting unit 22 are implemented by the software, the firmware, or the combination of software and firmware. The software or the firmware is described as a program and is stored in the memory hd2.

In the configuration Cs2, the processing circuitry (the processor hd1) reads the program stored in the memory hd2 and then executes the program, thereby implementing the functions of the calculating unit 21 and the setting unit 22. That is, the memory hd2 stores the program described below.

The above-mentioned program is the program to cause the processing circuitry (the processor hd1) to perform the step for calculating the coordinates of the plurality of video display apparatuses on the multiscreen on the basis of the transmission sequence and the arrangement information for specifying the arrangement configuration of the plurality of video display apparatuses, the step for calculating the identification number for identifying each of the plurality of video display apparatuses on the basis of the predetermined rule for setting the identification number to each of the plurality of video display apparatus, and the step for performing the processing for setting the identification number of each of the plurality of video display apparatuses with the calculated coordinates to the video display apparatus concerned.

The above-mentioned program causes the computer to implement, for example, the procedures of the processing performed by each of the calculating unit 21 and the setting unit 22 and the method for performing the processing.

In the configuration Cs3, a part of the functions of the calculating unit 21 and the setting unit 22 is implemented by the dedicated hardware. In the configuration Cs3, a part of the remaining functions of the calculating unit 21 and the setting unit 22 is implemented by the software or the firmware.

For example, the processing circuitry reads and executes the program stored in the memory, thereby implementing the function of the calculating unit 21. For example, the processing circuit being the dedicated hardware implements the function of the setting unit 22.

As in the above-mentioned configurations Cs1, Cs2, and Cs3, the processing circuitry can implement each of the functions described above through the hardware, the software, the firmware, or the combination of the above.

The present invention may be implemented as the identification number setting method or the identification address setting method including the steps of operations of the distinctive constitution components of the video display apparatus hz. In the present invention, each step included in the identification number setting method or the identification address setting method may be performed by the computer. In the present invention, each step included in the identification number setting method or the identification address setting method may be implemented as the program to be executed by the computer. The present invention may be implemented as the computer-readable storage medium that stores the program. The program may be distributed through the transmission medium such as the internet.

The identification number setting method according to the present invention is equivalent to the identification information setting correspondence processing BM in FIG. 11. The sequence in which each processing in the identification number setting method is performed is an example for specifically describing the present invention and is not limited to the above-described sequence. A part of the processing in the identification number setting method may be independently performed in parallel with the remaining part of the processing.

The identification address setting method according to the present invention is equivalent to the identification information setting correspondence processing NM in FIG. 19. The sequence in which each processing in the identification address setting method is performed is an example for specifically describing the present invention and is not limited to the above-described sequence. A part of the processing in the identification address setting method may be independently performed in parallel with the remaining part of the processing.

All of the values mentioned in the above preferred embodiments are examples for specifically describing the present invention. That is, in the present invention, the values are not limited to the values mentioned in the above preferred embodiments.

In the present invention, each preferred embodiment can be appropriately varied or omitted within the scope of the invention. For example, both the identification numbers i and the coordinates P are set to the individual video display apparatuses 100 in the first preferred embodiment, which is not limited thereto. For example, only the identification numbers i may be set to the individual video display apparatuses 100.

For example, both the identification address and the coordinates P are set to the individual video display apparatuses 100 in the second preferred embodiment, which is not limited thereto. For example, only the identification addresses may be set to the individual video display apparatuses 100.

The video display apparatus 100 in the first preferred embodiment shown in FIG. 4 includes only one external control terminal 34 as the interface for the network communication. Alternatively, the number of the external control terminal 34 included in the video display apparatus 100 may be two or more in another configuration (configuration X1).

While the invention has been shown and described in detail, the foregoing description is in all aspects illustrative and not restrictive. It is therefore understood that numerous modifications and variations can be devised without departing from the scope of the invention.

What is claimed is:

1. A multiscreen display apparatus, comprising a plurality of video display apparatuses arranged in matrix and daisy-chain connected through a communication cable such that screens of said plurality of video display apparatuses form a multiscreen having a rectangular shape, wherein
for said plurality of video display apparatuses, a transmission sequence in which information is transmitted between said plurality of video display apparatuses through said daisy chain connection is defined, and
a reference video display apparatus that comes first in said transmission sequence from among said plurality of video display apparatuses includes
processing circuitry
to calculate coordinates of said plurality of video display apparatuses on said multiscreen on the basis of said transmission sequence and arrangement information for specifying an arrangement configuration of said plurality of video display apparatuses, and
to calculate an identification number for identifying each of said plurality of video display apparatuses on the basis of a predetermined rule for setting said identification number to each of said plurality of video display apparatuses; and
to perform a processing for setting said identification number of each of said plurality of video display apparatuses with the calculated coordinates to said video display apparatus concerned.

2. The multiscreen display apparatus according to claim 1, wherein
said plurality of video display apparatuses are connected to the outside so as to form a network using a communication channel separate from another communication channel following said daisy chain connection,
said processing circuitry calculates an identification address for identifying each of said plurality of video display apparatuses in said network on the basis of a predetermined rule for setting said identification address to each of said plurality of video display apparatuses, and
said processing circuitry performs a processing for setting said identification address of each of said plurality of video display apparatuses with the calculated coordinates to said video display apparatus concerned.

3. The multiscreen display apparatus according to claim 1, wherein said arrangement information is composed of the number of rows and the number of columns of a matrix corresponding to said plurality of video display apparatuses arranged in matrix.

4. The multiscreen display apparatus according to claim 1, wherein said processing circuitry performs a processing for setting the coordinates of each of said plurality of video display apparatuses with the calculated coordinates to said video display apparatus concerned.

5. The multiscreen display apparatus according to claim 1, wherein
said reference video display apparatus is located in any one of four corners of said multiscreen, and
said processing circuitry calculates the coordinates on the basis of a position of said reference video display apparatus.

6. The multiscreen display apparatus according to claim 1, wherein said rule is defined on the basis of (a) a sequence according to a raster scanning in which a sequence of scanning starting from a reference position being a position of said reference video display apparatus in said multiscreen is changed in a direction horizontal to said multiscreen or (b) a sequence according to a raster scanning in which the sequence of scanning starting from the reference position is changed in a direction vertical to said multiscreen.
